(19) United States
(12) Patent Application Publication
(10) Pub. No.: US 2003/0080631 A1
(43) Pub. Date: May 1, 2003

(54) Sheet coils and linear motors comprising same, and stage units and microlithography apparatus comprising said linear motors

(75) Inventors: Shigeki Kageyama, Fukaya-shi (JP); Hisashi Tanimura, Kumagaya-shi (JP); Martin E. Lee, Saratoga, CA (US); Andrew J. Hazelton, San Carlos, CA (US)

Correspondence Address: KLARQUIST SPARKMAN CAMPBELL LEIGH & WHINSTON, LLP, One World Trade Center, Suite 1600, 121 S.W. Salmon Street, Portland, OR, 97204-2988, US

(73) Assignee: Nikon Corporation

(21) Appl. No.: 10/016,366

(22) Filed: Nov. 1, 2001

(51) Int. Cl. H02K 41/00; H02K 17/00; H02K 19/00; H02K 21/00

(52) U.S. Cl. 310/12; 310/208

(57) ABSTRACT

Sheet coils and linear motors including same are disclosed. Also disclosed are stage units, exposure devices, and microelectronic-device manufacturing methods employing the linear motors. The linear motors exhibit reduced viscous resistance. The sheet coil includes at least one coil formed as a conductive wiring trace on an insulative film substrate. The coil includes at least one slit extending in the coil-winding direction. The slit usually separates the coil into multiple partial coils that are connected to AC current having the same phase.

### FIELD OF THE INVENTION

This invention pertains to sheet coils, linear motors comprising sheet coils, stage devices comprising linear motors, lithographic exposure apparatus comprising stage devices, and microelectronic device manufacturing methods comprising one or more steps utilizing a lithographic exposure apparatus. The invention also pertains to sheet coils and armatures including sheet coils, wherein the armatures are movable relative to a magnetic stator or analogous device.

### BACKGROUND OF THE INVENTION

Linear motors (linear-servo motors) have been developed to solve the problem of achieving linear motion without having to translate rotational motion (from a conventional rotary motor) to linear motion. Linear motors can achieve accurate and highly controlled linear displacement without problems such as backlash. Also, linear motors achieve linear motion with extremely low vibration. Consequently, linear motors are used extensively in contemporary moving stage mechanisms such as used in any of various micro-electronic device fabrication methods. For example, microlithography apparatus include at least one stage (for holding a reticle or wafer) that is displaceable using a linear motor.

A linear motor typically has a stationary portion (termed a “stator”) and a movable portion (termed an “armature”). In a type of linear motor frequently used in micro-electronic-device fabrication apparatus, the stator defines a longitudinally extended slot in which the armature is inserted. The stator typically contains an array of permanent magnets that produce a cyclic distribution of magnetic flux density (see FIG. 31). The armature typically comprises an electromagnetic coil to which electric current is applied. The resulting interaction of the magnetic fields produced by the armature coil with the magnetic flux produced by the stator result in linear motion of the armature relative to the stator.

In the armatures of certain types of conventional linear motors a hexagonal coil 83 is used such as shown in FIGS. 30(A)-30(B). As can be seen in FIG. 30(A), the coil 83 has a hexagonal planar profile. The coil 83 is constructed by winding a copper wire in a planar hexagonal profile. Unfortunately, it is very difficult to form the wire into the desired coil profile within required dimensional tolerances and without causing detachment of the insulative coating on the wire.

To solve this problem, it recently has been proposed to incorporate a “sheet coil” 80, such as shown in FIG. 31, in the armature of a linear motor. Compared to the coil 83, a sheet coil advantageously can be formed accurately into a complex shape such as a hexagonal profile.

To make a conventional sheet coil, thin-film conductive wiring material is deposited on a thin, insulative sheet-coil substrate. The sheet coil 80 is fashioned by folding the sheet-coil substrate (with attached conductors) in an overlapping manner. Other approaches include forming the wiring material on the insulative sheet to the desired profile by patterning using a method such as pressing or etching.

Unfortunately, in an armature constructed using a conventional folded sheet coil 80, as the sheet coil 80 moves relative to the stator, a periodic (cyclically changing) magnetic flux from the stator passes through the coil 81. This generates an eddy current Iₑ within the wiring material forming the coil 81.

The eddy current Iₑ, in turn, produces moving direction and reverse-direction force components (viscous resistance) that are added to the driving force vector of the armature. An excessive viscous resistance causes a substantial reduction in the driving force applied to the armature, resulting in a corresponding loss of motor output. Hence, there is a need to reduce the viscous resistance as much as possible.

### SUMMARY OF THE INVENTION

In view of the shortcomings of the prior art as summarized above, an object of the invention is to provide sheet coils, linear motors incorporating the sheet coils, stage units incorporating the linear motors, exposure apparatus incorporating the stage units, and device-manufacturing methods that exhibit substantially reduced viscous resistance.

To such ends, and according to a first aspect of the invention, sheet coils are provided. An embodiment of such a sheet coil comprises an electrically insulative sheet substrate and at least one coil formed as a wiring trace of an electrically conductive material in a winding direction on the sheet substrate. The coil is divided by at least one “slit” (as described herein) extending in the wiring direction so as to form multiple partial coils of the coil. With such a structure, the width of the current path through the coil is reduced (compared to conventional sheet coils), with a corresponding increase in resistance. As a result, the eddy current generated in the coil is reduced compared to conventional sheet coils.

The sheet coil desirably comprises multiple coils, each having at least one slit. With respect to each coil, the constituent partial coils can be electrically separate from each other (due to the slit extending the full length of the coil). Alternatively, the partial coils of the coil can be connected to each other on the insulative substrate by “linking units” (as described herein).

Each coil desirably is formed of a respective wiring-trace pattern having a periodic fixed-waveform configuration. The sheet coil is formed by pleat-folding the insulative substrate (with wiring-trace patterns) along fold lines, extending perpendicular to the winding direction, regularly spaced from each other relative to the fixed-pattern waveform.

Various multi-coil configurations of the sheet coil can include as “connector unit” (as described herein). The connector unit desirably constitutes additional wiring traces, formed on the insulative substrate, serving to connect together selected partial coils. For example, the connector unit can be used to connect together multiple coils of a group of coils in a serial manner, while also serially connecting select partial coils of the group.

In the sheet coil, the number of partial coils can be equal to a divisor of a number of coils of the sheet coil that would face opposite an external magnetic field such as generated by a stator of a linear motor. In such a configuration, a connector unit can be used to connect partial coils of a group together in a serial manner while shifting the connection site of the partial coils by one for each connection.

In a multiple-coil embodiment of the sheet coil, the connector unit can be used to connect together the coils in a serial manner while also serially connecting the partial coils together. The partial coils are selected one at a time from the multiple coils for connection. The connector unit can use two partial coils, which are in symmetrical positions within the coil, to connect together partial coils in a serial manner.

According to another aspect of the invention, armatures for linear motors are provided. Each such armature includes a sheet coil according to the invention. Also provided are linear motors including such armatures. Also provided are stage units that comprise such linear motors.

The foregoing and additional features and advantages of the invention will be more readily apparent from the following detailed description, which proceeds with reference to the accompanying drawings.

### BRIEF DESCRIPTION OF THE DRAWINGS

FIG. 1 is an oblique elevational view, from a “front” surface, of a sheet coil according to the first representative embodiment.

FIG. 2 is an oblique elevational view, from a “rear” surface, of the sheet coil of FIG. 1.

FIG. 3 is a plan view of a sheet coil substrate as described in the first representative embodiment.

FIG. 4 is an elevational section along the line IV-IV in FIG. 3.

FIG. 5 shows the six coils, as arrayed in the y-direction and arranged into three groups, of the sheet coil described in the first representative embodiment.

FIG. 6 shows the electrical connections of the constituent partial coils of the first and second coils of an exemplary group in the sheet coil of the first representative embodiment.

FIG. 7 is an electrical schematic diagram of the electrical connections, electrodes, and coils shown in FIG. 6.

FIG. 8 shows a comparison of the eddy current Iₐ generated in partial coils of an exemplary coil in the first representative embodiment (right-hand side of figure) with the eddy current Iₐ generated in a coil of a conventional sheet coil (left-hand side of figure).

FIG. 9(A) is an electrical schematic diagram of exemplary equivalent circuits that generate counter-electromotive forces in the partial coils of a group of coils in the first representative embodiment.

FIGS. 9(B)-9(C) are electrical schematic diagrams of respective schemes for reducing eddy current feed back from one trace to other traces, as described in the fourth representative embodiment.

FIG. 10 includes plots of viscous resistance, wherein plot (a) denotes viscous resistance encountered by a sheet coil in a conventional linear motor, plot (b) denotes viscous resistance encountered by a sheet coil in a linear motor according to the first representative embodiment, and plot (c) denotes viscous resistance encountered by a sheet coil in a linear motor according to the fourth representative embodiment.

FIG. 11 shows the electrical connections of the constituent partial coils of the first, second, and third coils of an exemplary group in the sheet coil of the second representative embodiment.

FIG. 12 is an electrical schematic diagram of the equivalent circuits that generate counter-electromotive forces in the partial coils of a group of coils in the second representative embodiment.

FIG. 13 is a plan view of a first connector unit as used in the third representative embodiment.

FIG. 14 is a plan view of a second connector unit as used in the third representative embodiment.

FIG. 15 shows the pleat-folded configuration of the first connector unit in the third representative embodiment.

FIG. 16 depicts alignment of electrodes when performing a first soldering step involving the pleat-folded first connector unit in the third representative embodiment.

FIG. 17 depicts alignment of electrodes when performing a second soldering step involving the pleat-folded first connector unit in the third representative embodiment.

FIG. 18 is a plan view of an alternative connector unit as described in the third representative embodiment.

FIG. 19 shows the electrical connections of the constituent partial coils of the first and second coils of an exemplary group in the sheet coil of the fourth representative embodiment.

FIG. 20 is an electrical schematic diagram of the equivalent circuits that generate counter-electromotive forces in the partial coils of a group of coils in the fourth representative embodiment.

FIG. 21 is a plan view of connector units that can be used to connect together coils of respective groups in the fourth representative embodiment.

FIG. 22 is a plan view of the connector units, shown in FIG. 21, as attached to the respective coils.

FIGS. 23(A)-23(B) are plan views showing a first alternative manner in which slits can be configured on a coil so as to include linking units at every cycle, to link together adjacent partial coils electrically. FIG. 23(A) depicts the wiring-trace pattern, and FIG. 23(B) depicts a coil.

FIGS. 24(A)-24(B) are plan views showing a second alternative manner in which slits can be configured on a coil so as to include linking units at every half cycle, to link together adjacent partial coils electrically. FIG. 24(A) depicts the wiring-trace pattern, and FIG. 24(B) depicts a coil.

FIG. 25 is an oblique view of a linear motor according to the fifth representative embodiment.

FIG. 26 is an oblique view of a stage unit, according to the sixth representative embodiment, including a linear motor such as described in the fifth representative embodiment.

FIG. 27 is a schematic elevational diagram of a microlithography apparatus, according to the seventh representative embodiment, including a stage unit such as described in the sixth representative embodiment, which includes a linear motor such as described in the fifth representative embodiment.

FIG. 28 is a block diagram of an exemplary process for manufacturing a microelectronic device, the process including use of a microlithography apparatus according to the invention.

FIG. 29 is flowchart of details of the substrate-processing step of FIG. 28.

FIGS. 30(A)-30(B) are a plan view and orthographic edge view, respectively, of a conventional hexagonal planar coil.

FIG. 31 is an oblique view of a conventional sheet coil and certain electrical and magnetic influences on the sheet coil when used in the armature of a linear motor.

FIG. 32 depicts certain details of a moving-magnet type of linear motor incorporating features of the invention, as described in connection with the second representative embodiment.

### DETAILED DESCRIPTION

This invention is described below in the context of multiple representative embodiments that are not intended to be limiting in any way.

A “sheet coil” comprises at least one electrical conductor that functions as an electrical coil but either is configured and used as a sheet (substantially two-dimensional configuration; see FIG. 31) or is formed initially as a sheet and subsequently wound or folded so as to have a three-dimensional configuration for use.

### First Representative Embodiment

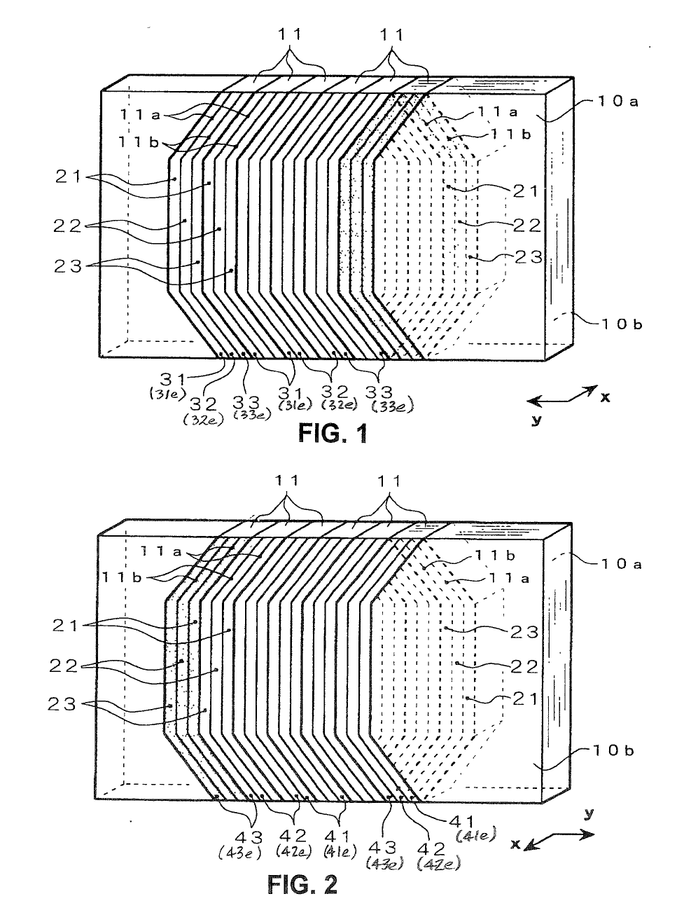

A sheet coil 10 according to this embodiment is shown in FIGS. 1 and 2. The depicted sheet coil is especially suitable for incorporation into an armature of a moving-coil type linear motor.

The sheet coil 10 comprises six coils 11 arrayed in the y-axis direction adjacent to each other. To aid visualization of the configuration of a single coil, the right-hand coil 11 is shaded slightly in FIG. 1 (the shaded coil is the left-hand coil in FIG. 2). The winding axis (x-axis) of the coils 11 and the array axis (y-axis) of the six coils 11 are substantially orthogonal to each other. As explained in detail later below, the sheet coil 10 comprises a thin sheet-coil substrate 12 that is folded into pleats that are “stacked” in the x-axis direction.

The general configuration of the pleat-folded sheet coil 10 is substantially a rectangular parallelepiped as shown in FIGS. 1 and 2. For convenience, of the six outer “surfaces” of the sheet coil 10, the two outer surfaces extending parallel to the array axis (y-axis) and orthogonal to the winding axis (x-axis) are termed the front surface 10a and rear surface 10b. In FIG. 1 the front surface 10a of the sheet coil 10 is shown. On the front surface 10a are the first ends 31, 32, 33 of each of the six coils 11. In FIG. 2, the rear surface 10b of the sheet coil 10 is shown. On the rear surface are the second ends 41, 42, 43 of each of the six coils 11. (The reason why each coil has three first ends 31-33 and three second ends 41-43 will be apparent from discussion later below.)

Each of the coils 11 is configured with two “slits” 10a, 11b. In each coil 11, the two slits 11a and 11b extend along the winding direction of the coil. The slits 11a, 11b essentially divide the respective coil into three portions (“coil portions” or “partial coils”) 21, 22, 23 having first ends 31, 32, 33, respectively, and second ends 41, 42, 43, respectively. The slits 11a, 11b extend between the first ends 31-33 and the second ends 41-43 of each coil 11. On each of the first ends 31-33 is a respective first-end electrode 31e, 32e, 33e, and on each of the second ends is a respective second-end electrode 41e, 42e, 43e. Thus, although each coil 11 is divided into three partial coils 21, 22, 23, electrical current of the same phase is supplied to each of the partial coils 21, 22, 23 of a given coil 11, as described later below.

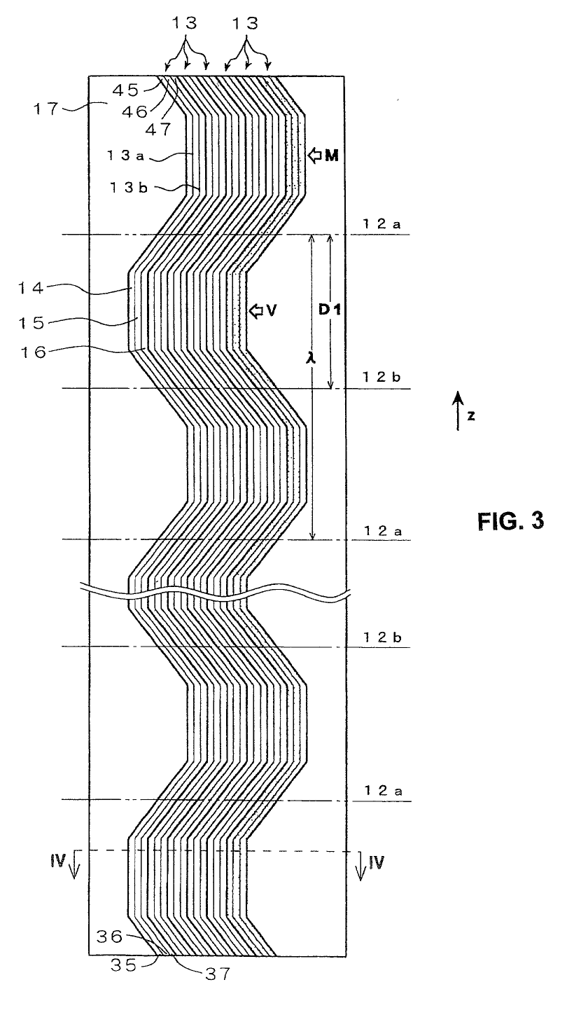

Turning now to FIG. 3, the sheet coil substrate 12 is pleat-folded with multiple “mountain folds” 12a (denoted by respective dot-dot-dash lines) and “valley folds” 12b (denoted by respective dot-dash lines). The mountain folds 12a and valley folds 12b are arrayed in alternating order equidistant from one another by the dimension D1. Each fold 12a, 12b extends in a direction orthogonal to the length direction (z-axis direction) of the sheet-coil substrate 12. Hence, as the sheet-coil substrate 12 is folded, all the mountain folds 12a and all the valley folds 12b are placed adjacent each other, respectively, to yield the desired pleated configuration of the folded sheet-coil substrate 12. The overall configuration of the pleat-folded sheet coil 10 is a substantially rectangular parallelopiped as shown in FIGS. 1 and 2.

On the sheet-coil substrate 12 prior to folding, the coils 11 are defined as respective wiring-trace patterns 13 that generally extend in the z-axis direction adjacent to each other in a trapezoidal profile (FIG. 3). In FIG. 3, to aid visualization of the wiring-trace patterns 13 of a single coil, the right-hand wiring-trace pattern 13 is shaded slightly. Also, the amplitude direction of all wiring-trace patterns 13 is orthogonal to the length dimension (z-axis), and the cycle and amplitude of all the wiring-trace patterns 13 are identical.

For each wiring-trace pattern 13, the cycle (wavelength λ) is twice the inter-fold dimension D1. The wiring-trace patterns 13 are formed so that the mountain folds 12a and the valley folds 12b are situated intermediate the respective centers of “mountains” (“M”) and “valleys” (“V”). By way of example, each wiring-trace pattern 13 is made from a thin film of conductive material (e.g., copper foil) and has a thickness of approximately 70 μm.

In this embodiment, each wiring-trace pattern 13 includes two “slits” 13a, 13a (corresponding to the slits 11a, 11b discussed above). The two slits 13a, 13b have respective profiles that conform to the “waveform” of the respective wiring-trace pattern 13, and extend from a first end 35, 36, 37 (corresponding to the first end 31, 32, 33) to a second end 45, 46, 47 (corresponding to the second end 41, 42, 43). Thus, the slits 13a, 13a effectively divide each respective wiring-trace pattern 13 into three individual wiring traces or conductors 14, 15, 16.

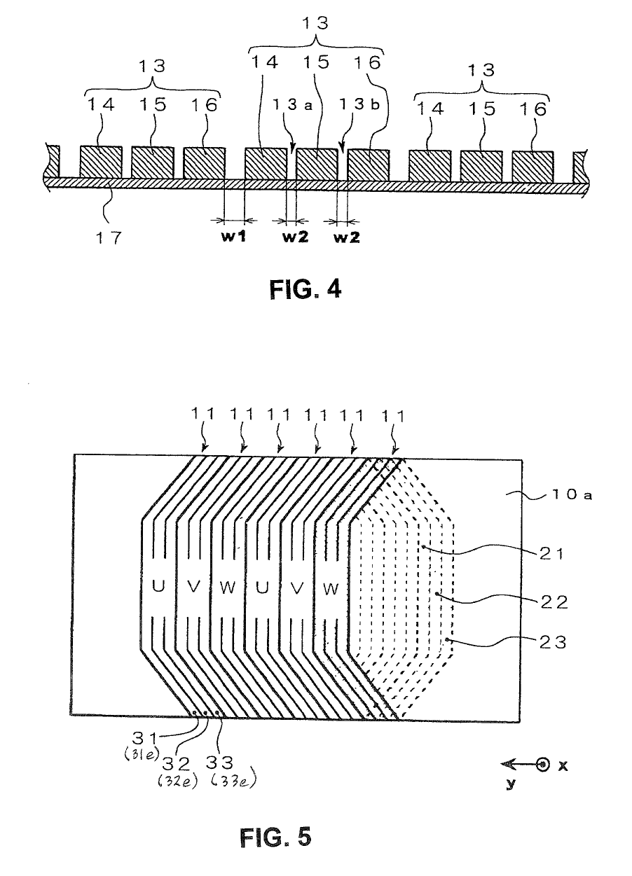

Turning now to FIG. 4, a section is shown along the line IV-IV of FIG. 3. As can be seen, the wiring-trace patterns 13 are formed on an insulative sheet 17 (by way of example, made of polyimide with a thickness of approximately 12.5 μm). The wiring-trace patterns 13 are separated from each other by a space having a width denoted w₁ and extending depthwise to the insulative sheet 17. With respect to each wiring-trace pattern 13, each of the slits 13a, 13a has a width w₂ that desirably is narrower than w₁. The slits 13a, 13a separate the respective wiring-trace pattern 13 into the individual conductors 14, 15, 16. Each slit 13a, 13a desirably extends depthwise to the insulative sheet 17.

Each wiring-trace pattern 13 (i.e., each of the conductors 14, 15, 16 of each wiring-trace pattern 13) desirably is covered by an insulative film (not shown, but having a thickness of approximately 12.5 μm). The insulative film can be formed or applied using a lamination process, for example. The insulative film is not present on the ends 35, 36, 37 and 45, 46, 47 of the respective conductors 14, 15, 16 of each wiring-trace pattern 13. Thus, the “electrodes” 31e-33e and 41e-43e, respectively, are formed that allow connection of external wiring to the conductors 14-16, respectively, as described later below.

As a result of folding the sheet-coil substrate 12 into pleats along the mountain folds 12a and the valley folds 12b, each wiring-trace pattern 13 (including respective conductors 14, 15, 16) formed on the sheet-coil substrate 12 is folded every half cycle (λ/2) and becomes a respective individual hexagonal coil 11 (including constituent partial coils 21, 22, 23), as shown in FIGS. 1 and 2. Also, as noted above, the exposed first ends 35, 36, 37 of the conductors 14, 15, 16 become the electrodes 31,e, 32e, 33e of the first ends 31, 32, 33 of the partial coils 21, 22, 23, respectively. Similarly, the second ends 45, 46, 47 of the conductors 14, 15, 16 become the electrodes 41e, 42e, 43e of the second ends 41, 42, 43 of the partial coils 21, 22, 23.

The sheet coil 10 of this embodiment, produced by pleat-folding the sheet-coil substrate 12, has six coils 11 (each including constituent partial coils 21, 22, 23) electrically connected in a manner allowing the sheet coil 10 to be incorporated into an armature of a moving-coil type linear motor.

The six coils 11 (each including constituent partial coils 21, 22, 23) are connected to three-phase alternating current (U phase, V phase, and W phase). The phases differ from each other by 120°. To such end, the six coils 11 are divided into three groups of two coils 11 each, as shown in FIG. 5. In each group, the partial coils 21, 22, 23 are connected together serially, in a manner utilizing the first-end electrodes 31e, 32e, 33e and the second-end electrodes 41e, 42e, 43e. A respective phase (U, V, or W) is supplied to each group. As shown in FIG. 5, the coils 11 energized with U-phase power are separated from each other by respective coils energized with V-phase power and W-phase power. Similarly, the coils 11 energized with V-phase power are separated from each other by respective coils energized with W-phase power and U-phase power, and coils 11 energized with W-phase power are separated from each other by respective coils energized with U-phase power and V-phase power. Hence, the depicted order of coils is U, V, W, U, V, W.

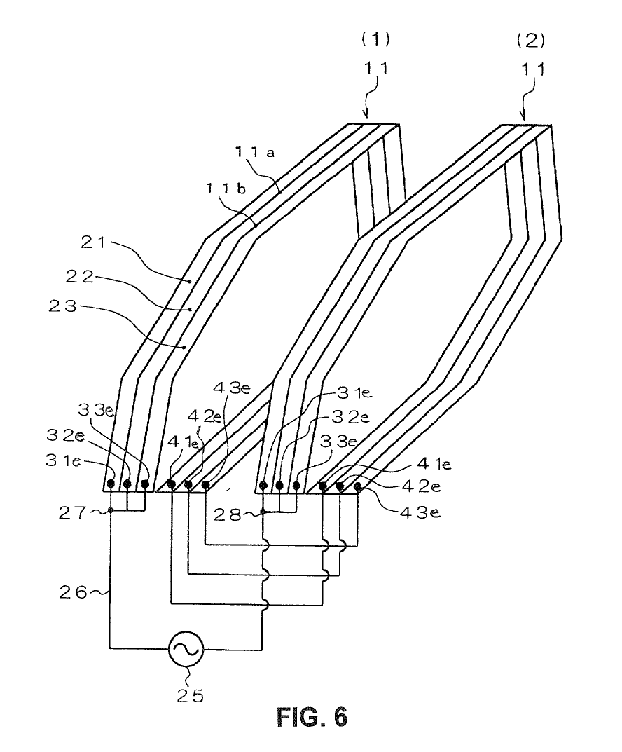

As understood from FIG. 6, the two respective coils 11 that form each group U, V, and W are connected together using the respective first-end electrodes 31e, 32e, 33e and respective second-end electrodes 41e, 42e, 43e. (In FIG. 6, only the connections for one group are shown.) Also, in FIG. 6, each coil 11 is shown in a simplified manner with only one winding shown, and the first-end electrodes 31e, 32e, 33e and second-end electrodes 41e, 42e, 43e are shifted laterally in the figure for clarity.

Further regarding FIG. 6, one of the two coils 11 of a group (i.e., coil (1) on the left-hand side) is termed a “first coil 11,” and the other of the two coils of the group (i.e., coil (2) at the right-hand side) is termed a “second coil 11.” With respect to the first coil and second coil, the respective individual second-end electrodes 41e, 42e, 43e are connected to each other electrically. An alternating current (AC) supply 25 delivering power having a designated phase (U, W, or V phase) is connected between the first-end electrodes 31e, 32e, 33e of the first coil 11 and the first-end electrodes 31e, 32e, 33e of the second coil 11. These connections can be made using, for example, copper wires 26.

Also, for connecting the second-end electrodes 41e, 42e, 43e of the first coil 11 and the second-end electrodes 41e, 42e, 43e of the second coil 11, the electrodes 41e are connected together individually, the electrodes 42e are connected together individually, and the electrodes 43e are connected together individually using separate wires 26 (e.g., copper wires).

The first-end electrodes 31e, 32e, 33e of the first coil 11 are connected together at a connection point 27, which is connected to one output terminal of the AC supply 25. Similarly, the first-end electrodes 31e, 32e, 33e of the second coil 11 are connected together at a connection point 28, which is connected to the other output terminal of the AC supply 25.

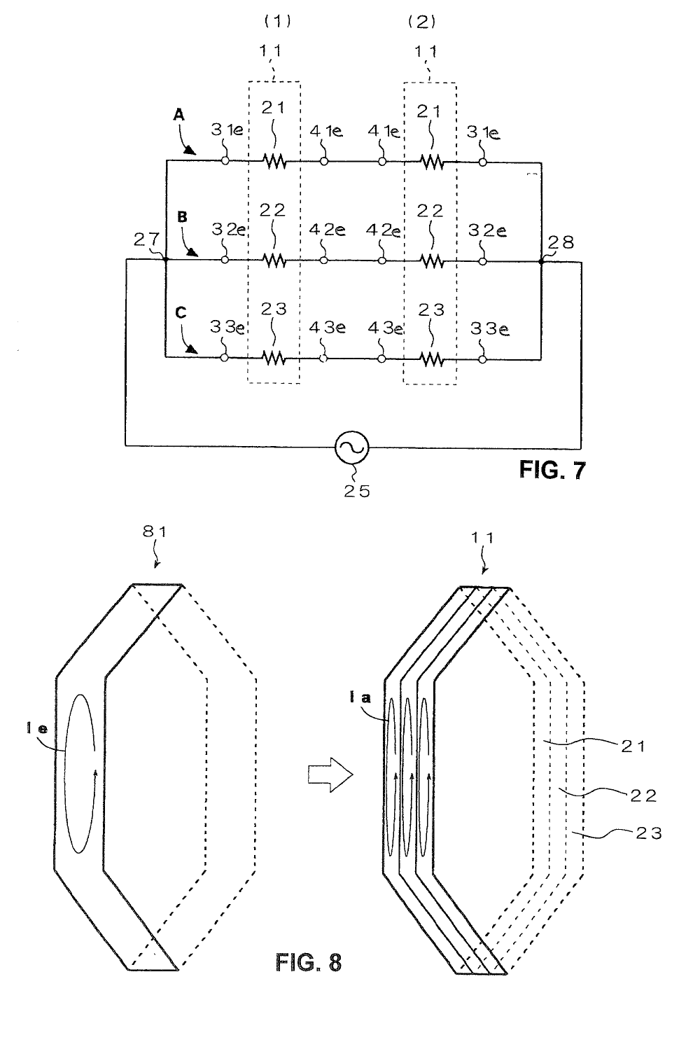

The interconnections of the first and second coils 11 shown in FIG. 6 can be represented schematically by the circuit diagram of FIG. 7. With respect to the group of coils 11 shown in FIGS. 6 and 7, alternating current from the AC supply 25 flows between the connection point 27 and the connection point 28. From the connection point 27, the current flows through three parallel paths A, B, C (FIG. 7). Path A comprises a serial connection of the two partial coils 21, path B comprises a serial connection of the two partial coils 22, and path C comprises a serial connection of the two partial coils 23. Similar connections are made for the constituent partial coils 21, 22, 23 of the other two groups V, W of coils 11. Each group receives power of a respective phase U, V, W from the AC supply 25.

As noted above, the sheet coil 10 of this embodiment can be incorporated into an armature of a moving-coil type three-phase linear motor. The armature is used in connection with a “stator” containing magnets that collective produce a cyclical distribution of magnetic flux density. The half-cycle of the distribution of magnetic flux density produced by the stator is about equal to the interval of the coils 11 of each group U, V, W as arranged in the y-direction (FIG. 1). During operation of the linear motor, the armature (containing the sheet coil 10 of this embodiment) moves relative to the magnetic field produced by the stator. The prevailing magnetic fields and movement generate an eddy current in each constituent coil 11 of the sheet coil 10. However, in this embodiment, each coil 11 includes two slits 11a, 11b that divide the coil into respective partial coils 21, 22, 23. In each partial coil 21, 22, 23, the current path is narrow, with relatively high electrical resistance. As shown in FIG. 8, the eddy current Iₐ produced by individual partial coils is reduced substantially compared to the eddy current Iₑ produced by a conventional coil 81. The reduced eddy current Iₐ is manifest as substantially reduced viscous resistance (relative to conventional linear motors in which the coils 81 in the sheet coil 80 (FIG. 31) of the armature lacks slits) encountered by the armature moving relative to the stator.

Whenever the sheet coil 10 of this embodiment moves relative to the stator (wherein the stator produces a magnetic field having a cyclical distribution of magnetic flux density), the stator magnetic flux Φ “seen” by each coil 11 changes, and a counter-electromotive force (“counter-EMF”) E is generated (E∝dΦ/dt). However, in this embodiment, each coil 11 is divided into three partial coils 21, 22, 23, and the respective positions of the partial coils 21, 22, 23 relative to the distribution of magnetic flux is different. As a result, at any instant in time, the instantaneous rate of change of the stator magnetic flux Φ“seen” by each partial coil 21, 22, 23 is different, causing the generated counter-EMF E to be different for each partial coil. The respective counter-electromotive force E generated by the partial coils 21, 22, 23 is denoted respectively by E₁, E₂, and E₃ (wherein E₁≠E₂≠E₃).

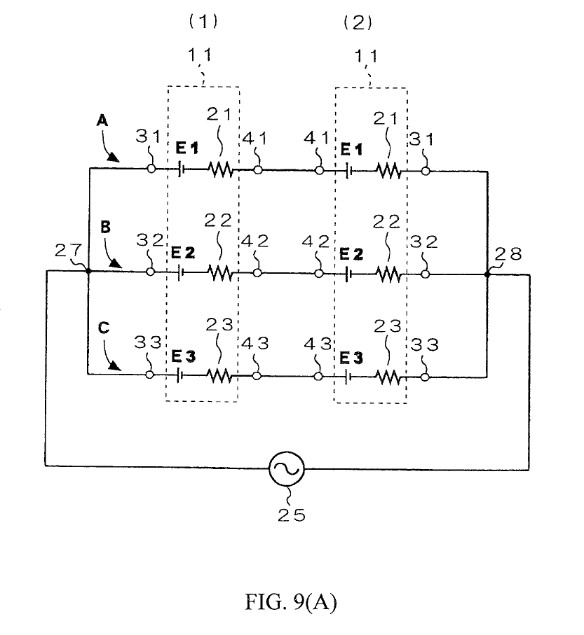

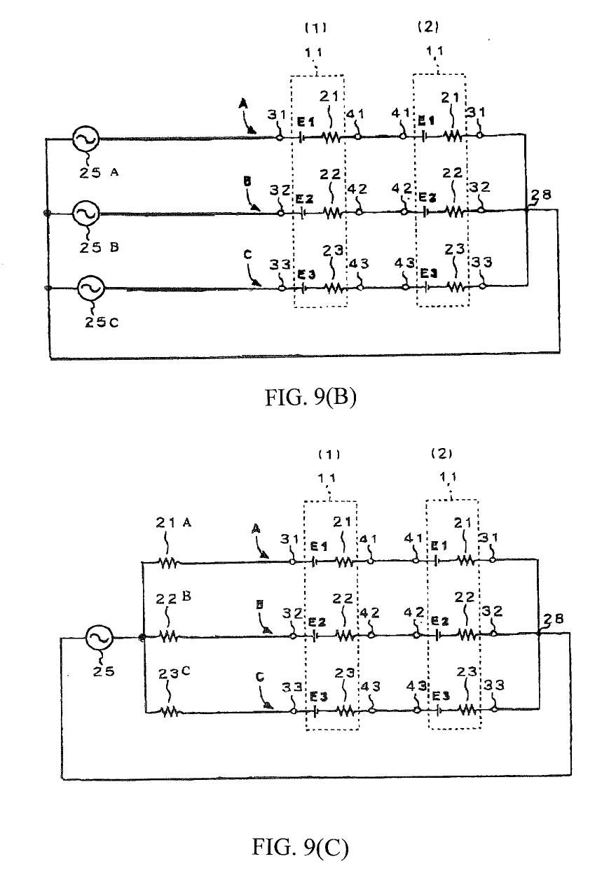

When considering the respective counter-EMFs E₁, E₂, E₃ generated at the partial coils 21, 22, 23 of each coil 11, an exemplary equivalent circuit of each group (U, V, W) of the coils 11 of the sheet coil 10 is shown in FIG. 9(A). Each of the three paths A, B, C are connected in parallel, and the circuit is closed by passing AC current of a given phase through the connection points 27, 28. In path A, a respective counter-EMF E₁ is generated by each partial coil 21 in the path. The sum ΣEₐ of the counter-EMFs for path A is ΣEₐ=E₁+E₁. Similarly, the sum E_{b} of the counter-EMFs for path B is E_{b}=E₂+E₂, and the sum ΣE_{c} of the counter-EMFs for path C is ΣE_{c}=E₃+E₃. As noted above, E₁≠E₂≠E₃. Consequently, ΣEₐ≠ΣE_{b}≠ΣE_{c}. In other words, at any instant in time, electric potential differences exist between the parallel paths A, B, C. As a result, a new current I_{b}, different from the eddy current Iₐ (FIG. 8) flows through the closed loop and through the connection points 27, 28 according to these electric-potential differences. The new current I_{b} is termed the “loop current I_{b}”. The direction and magnitude of the loop current I_{b} are determined by the size relationships of ΣEₐ, ΣE_{b}, and ΣE₁. Of these sums ΣEₐ, ΣE_{b}, ΣE_{c}, the greater the difference between the largest and smallest sum, the larger the loop current I_{b}.

The loop current I_{b} generated in this way behaves essentially in the same way as the eddy current Iₐ. I.e., the loop current I_{b} produces a “viscous resistance” encountered by an armature comprising the sheet coil 10. The viscous resistance due to the loop current I_{b} is proportional to the magnitude of the loop current I_{b} and can be large. With a sheet coil 10 according to this embodiment, by including two slits 11a and 11b in each coil 11, the eddy current Iₐ generated in each partial coil 21, 22, 23 is reduced, yielding a reduced viscous resistance due to the eddy current Iₐ. Hence, even if there is increased viscous resistance due to the loop current I_{b}, the total viscous resistance encountered by the armature in the linear motor is reduced compared to a conventional linear motor such as shown in FIG. 31.

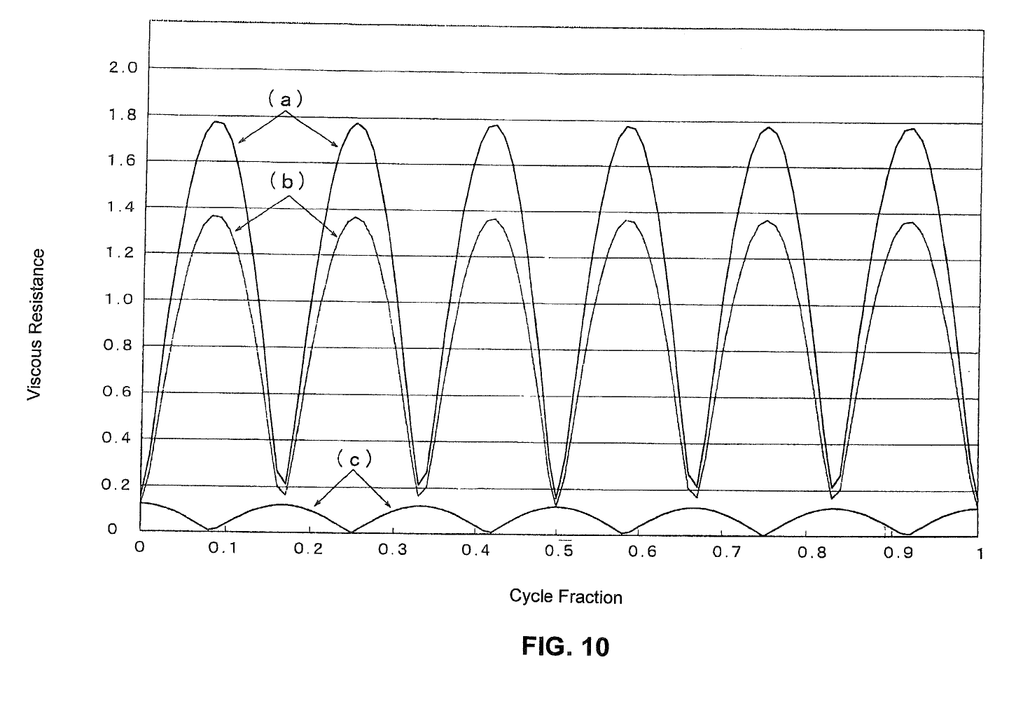

FIG. 10 is a plot of viscous resistance. Plot (a) is the total viscous resistance encountered by the conventional sheet coil 80 (FIG. 31), and plot (b) is the viscous resistance encountered by the sheet coil 10 of this embodiment. By comparing plots (a) and (b) in FIG. 10, it can be seen that viscous resistance is reduced by about 30% in a linear motor including the sheet coil 10 of this embodiment, compared to a conventional linear motor including the sheet coil 80 (FIG. 31). The plot (c) is described later below in connection with the fourth representative embodiment.

In the sheet coil 10 of this embodiment, each coil 11 comprises two slits 11a, 11b that divide the coil 11 into three partial coils 21, 22, 23. However, the number “n” of partial coils and the number (n−1) of slits is not limited to n=3. Even in configurations in which n is any integer of 2 or greater, the eddy current Iₐ generated by each of the partial coils is reduced compared to the prior art.

With respect to reducing the eddy current Iₐ generated by each partial coil, the higher the number n of partial coils, the thinner each individual partial coil and the smaller the eddy current Iₐ, which is desirable. However, as the number (n−1) of slits increases with n, the transverse section of conductive material for each coil 11 is reduced accordingly. This causes the resistance of each coil 11 to increase, which is thermally disadvantageous. Therefore, with the sheet coil 10 of this embodiment, it is desirable that the partial-coil count n and the slit count (n−1) be optimized to achieve a desired performance of the linear motor (e.g., within established limitations on viscous resistance and/or rise in operating temperature).

In this embodiment, the sheet coil 10 is described above in the context of use in a moving-coil type linear motor. Alternatively, the sheet coil 10 can be used as a sheet coil in a moving-magnet type linear motor.

### Second Representative Embodiment

A sheet coil according to this embodiment, as in the first representative embodiment, is a sheet coil especially adapted for use in a moving-coil type three-phase linear motor. The main differences between the sheet coil of this embodiment and the sheet coil 10 of the first representative embodiment are the number of coils 11 and the electrical connections between the coils 11. Other structures (including the structure of the coil 11 itself) are the same as in the sheet coil 10, and further description of such structures is not given below.

The sheet coil of this embodiment includes nine coils 11 arrayed adjacent to each other in the array (y-axis) direction. For supplying AC power of three phases (U phase, V phase, and W phase) to the sheet coil of this embodiment, the nine coils 11 are divided into three groups. The coils in each group are connected together serially. Each group includes three coils 11. The coils 11 of each group (e.g., the U-phase group) are interspersed among the coils 11 of the other groups (i.e., the V-phase group and the W-phase group; see FIG. 5).

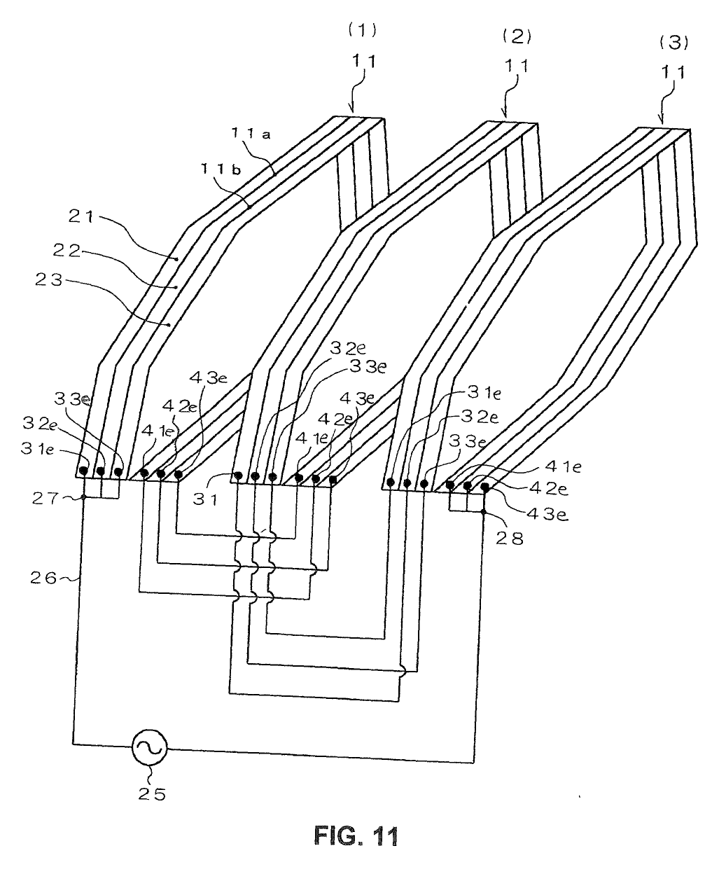

As shown in FIG. 11, the connection of the respective three coils 11 that form each group is made using the respective first-end electrodes 31e, 32e, 33e and the respective second-end electrodes 41e, 42e, 43e. (In FIG. 11, only the connections for one group of coils is shown. Of this group as depicted, the left-hand coil is termed the “first coil” 11, the middle coil is termed the “second coil” 11, and the right-hand coil is termed the “third coil” 11.) Each coil 11 is simplified by being shown with only one turn per coil 11, and the first-end electrodes 31e, 32e, 33e and second-end electrodes 41e, 42e, 43e are shown laterally shifted for clarity.

Referring further to FIG. 11, and with respect to the first and second coils 11, the second-end electrodes 41e, 42e, 43e are connected electrically together (i.e., the second-end electrodes 41e, 42e, 43e of the first coil 11 are connected individually to the second-end electrodes 42e, 43e, 41e, respectively, of the second coil 11). With respect to the second and third coils 11, the first-end electrodes 31e, 32e, 33e are connected together electrically (i.e., the first-end electrodes 31e, 32e, 33e of the second coil 11 are connected individually to the first-end electrodes 32e, 33e, 31e, respectively, of the third coil 11). Hence, with respect to these interconnected electrodes, the electrode to which each electrode is connected is shifted by one place. An AC current supply 25 delivering power having a designated phase (U phase, W phase, or V phase) is connected between the first-end electrodes 31e, 32e, 33e of the first coil 11 and the second-end electrodes 41e, 42e, 43e of the third coil 11. These interconnections can be made using copper wires 26.

The other two groups of coils 11 in this embodiment are interconnected in a manner similar to that shown in FIG. 11. Each group of coils 11 is energized by AC current but at a different respective phase. Hence, one group receives U-phase power, another group receives V-phase power, and the remaining group receives W-phase power. Each phase is 120° shifted relative to the other two phases.

During operation of a moving-coil type three-phase linear motor according to this embodiment, the armature (comprising the sheet coil of this embodiment) moves relative to the magnetic field, having a cyclical distribution of magnetic flux, produced by the stator. The instantaneous rate of change of the stator magnetic flux Φ “seen” by each partial coil 21, 22, 23 is a function of the position of the respective partial coil 21, 22, 23 relative to the magnetic flux produced by the stator. As a result, different counter-EMFs E₁, E₂, E₃ are generated at each partial coil 21, 22, 23, respectively (E₁≠E₂≠E₃).

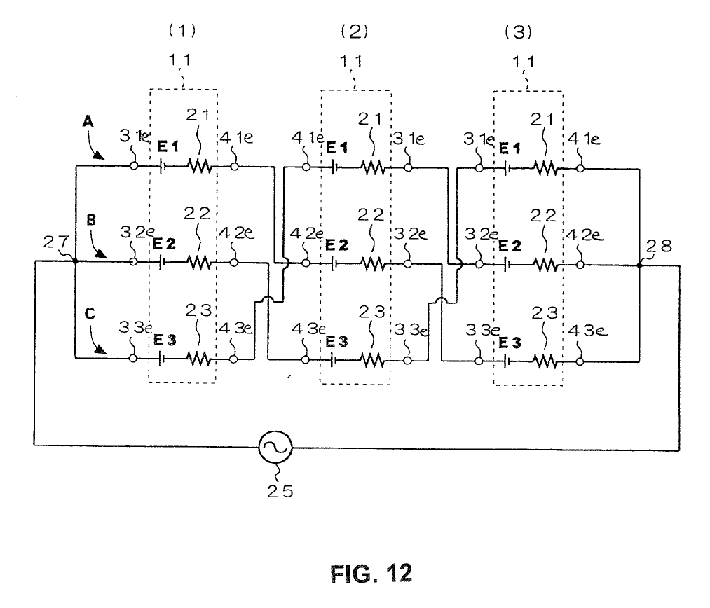

When considering the counter-EMFs E₁, E₂, E₃ generated at the partial coils 21, 22, 23, respectively, of each coil 11 of this embodiment, the equivalent circuit of each group of coils 11 is shown in FIG. 12. In each group, the partial coils form three respective paths A, B, C connected in parallel. The circuit is closed by connecting the AC current supply to the connection points 27, 28. Path A comprises a serial connection between partial coils 21, 22, and 23 of the first, second, and third coils, respectively. With respect to path A, a counter-EMF E₁ is generated by each partial coil 21, and respective counter-EMFs E₂ and E₃ are generated for each partial coil 22 and 23, respectively. The sum of the counter-EMFs for path A is ΣEₐ=E₁+E₂+E₃. Path B comprises a serial connection between partial coils 22, 23, and 21 of the first, second, and third coils, respectively. With respect to path B, a counter-EMF E₂ is generated by each partial coil 22, and respective counter-EMFs E₃ and E₁ are generated for each partial coil 23 and 21, respectively. The sum of the counter-EMFs for path B is ΣE_{b}=E₂+E₃+E₁. Path C comprises a serial connection between partial coils 23, 21, and 22 of the first, second, and third coils, respectively. With respect to path C, a counter-EMF E₃ is generated by each partial coil 23, and respective counter-EMFs E₁ and E₂ are generated by the partial coils 21 and 22, respectively. The sum of the counter-EMFs for path C is ΣE_{c}=E₃+E₁+E₂.

As described above, the counter-EMFs E₁, E₂, E₃ generated by the partial coils 21, 22, 23, respectively, differ from each other (i.e., E₁≠E₂≠E₃). However, by connecting the partial coils together in the manner, described above, in which the electrodes are shifted one place (41e to 42e, 42e to 43e, 43e to 41e, 31ₑ to 32e, 32e to 33e, 33e to 31e), differences in counter-EMF are cancelled. As noted above, the respective sums of counter-EMF (ΣEₐ, ΣE_{b}, ΣE_{c}) are equal to each other (i.e., ΣEₐ=ΣE_{b}=ΣE_{c}). As a result, the respective electrical potential difference between any of the parallel paths A, B, and C is zero, and a loop current I_{b} does not flow through the circuit via the connection points 27, 28.

Whenever the sheet coil of this embodiment is moved relative to a stator that produces a cyclical distribution of magnetic flux density, an eddy current Iₐ is generated at each coil 11. However, with the sheet coil of this embodiment, each coil 11 includes two slits 11a, 11b, that divide the respective coil 11 into three respective partial coils 21, 22, 23. Consequently, the width of each path for electrical current flow is narrowed correspondingly. This increases resistance and reduces the eddy current Iₐ generated in each partial coil 21-23, compared to conventional configurations (see FIG. 8).

As noted above, a sheet coil according to this embodiment produces substantially no loop current I_{b}, which reduces the corresponding viscous resistance (otherwise due to the loop current I_{b}) to zero. Also, because the eddy current Iₐ is small, the corresponding viscous resistance (due to the eddy current Iₐ) is decreased. The overall result is a decreased viscous resistance, even compared to the sheet coil 10 of the first representative embodiment.

In an alternative configuration to the electrode-interconnection scheme described above (i.e., 41e to 42e, 42e to 43e, 43e to 41e, 31e to 32e, 32 to 33e, 33e to 31e), the electrode interconnections can be reversed (i.e., 41e to 43e, 42e to 41e, 43e to 42e, 31e to 33e, 32e to 31e, 33e to 32e).

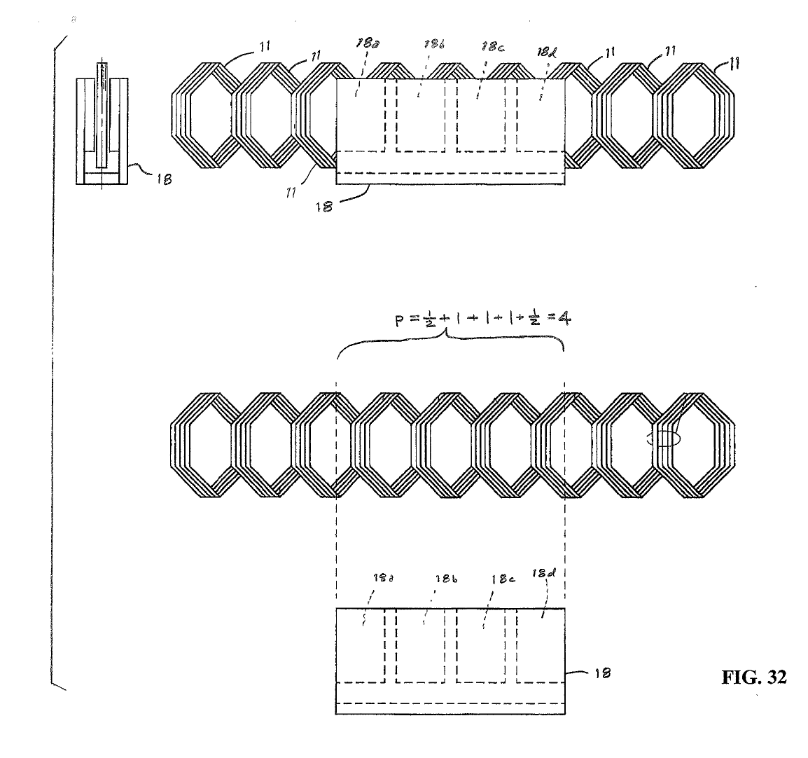

In the foregoing description of this embodiment, each group consisted of three coils 11, and each constituent coil included two slits 11a and 11b that divided the respective coil into three respective partial coils 21, 22, 23. With respect to this embodiment in general, the number of coils 11 that form each group is denoted “m” (wherein m is an integer and m≧2). The number of slits in each coil is (m−1), thereby producing “n” partial coils (wherein n=m). Within each group of coils, a closed electrical circuit is formed having m paths (A, B, C, . . . ) connected in parallel (see the equivalent circuit of FIG. 12). Also, for each of the m partial coils, different counter-EMFs E₁, E₂, E₃, . . . Eₘ are generated. The sum of counter-EMFs for the m paths (ΣEₐ, ΣE_{b}, ΣE_{c}, . . . ) is E₁+E₂+E₃+ . . . +Eₘ, resulting in a loop current I_{b} of zero. With m coils 11 forming each group, each coil 11 can be divided with (k−1) slits such that the number of partial coils is equal to the “divisor k (including m) of the coil count m.” In such an instance, again, the loop current I_{b} is zero.

Whereas this embodiment was described in the context of a sheet coil incorporated into a moving-coil type of linear motor, it also is possible to use the sheet coil in a moving-magnet type of linear motor, in which partial coils can be serially connected together in each group. In the moving-magnet type of linear motor, as shown in FIG. 32, the coils 11 (m=9 as shown) are stationary and a “relative moving member” 18 moves relative to the coils 11. The relative moving member 18 does not overlie all the coils 11 but rather only some of them (total of four as shown). The relative moving member 18 comprises four magnetic elements 18a-18d. Only a portion of each coil 11 actually faces the magnetic elements 18a-18d of the relative moving member 18, contributing to the generation of drive force. The counter-EMF is generated only in those partial coils that face the magnetic elements 18a-18d of the relative moving member 18. As a result, in dividing each of the coils 11 into respective multiple partial coils n (n=4 as shown), it is not necessary to deal with all m (m=9) of the coils 11. Rather, the number of partial coils n can be established according to “p” (the number of coils 11, of all the m coils, that actually face the magnetic elements 18a-18d of the relative moving member 18). In this configuration, the number of partial coils in each coil 11 can be p or a divisor of p. Of course, the number of slits in each coil 11 is p−1.

### Third Representative Embodiment

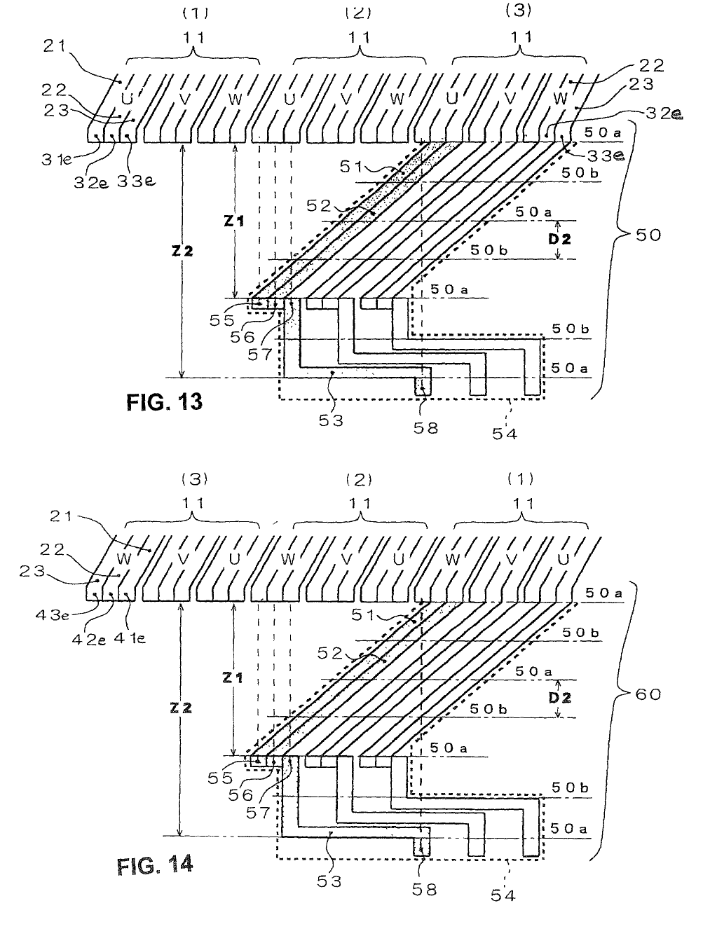

In this embodiment, a sheet-coil substrate is folded into pleats, as described above. The sheet-coil substrate includes nine coils 11 interconnected as described above in the second representative embodiment. As in the sheet-coil substrate of FIG. 3, nine wiring-trace patterns (having conforming trapezoidal profiles) are formed adjacent each other on a sheet-coil substrate. FIG. 13 shows a first end of the sheet-coil substrate with first-end electrodes 31e, 32e, 33e of the coils 11, and FIG. 14 shows a second end of the sheet-coil substrate with the second-end electrodes 41e, 42e, 43e of the coils 11. A first connector unit 50 is provided on the first end of the sheet-coil substrate for connecting certain of the first-end electrodes 31e, 32e, 33e of the coils 11 (FIG. 13). A second connector unit 60 is provided on the second end of the sheet-coil substrate for connecting certain of the second-end electrodes 41e, 42e, 43e of the coils 11 (FIG. 14). In each of FIGS. 13 and 14, coils 11 energized with U-phase power are denoted “U”, coils 11 energized with V-phase power are denoted “V”, and coils 11 energized with W-phase power are denoted “W”. Three groups of coils 11 are represented, according to the phase with which the respective coils are energized, and each group consists of three respective coils. The coils 11 also are grouped into three groups based on sequential position. Beginning from the left in FIG. 13, the first three coils are group (1), the second three coils are group (2), and the last three coils are group (3).

Referring to FIG. 13, the connector unit 50 is used to connect coils 11 of the second group (2) with coils 11 of the third group (3). The first-end electrodes of these coils are connected, from the second group (2) to the third group (3), as follows: 31e to 32e, 32e to 33e, and 33e to 31e (see FIG. 11). To such ends, the connector unit 50 includes linear wiring traces 51, 52 extending diagonally from the first-end electrodes 32e, 33e, respectively, of the second and third partial coils 22, 23, respectively, of each of the coils 11 in the third group (3). The wiring traces 51, 52 are used to connect the first-end electrodes 32e, 33 e of the coils 11 in the third group with the first-end electrodes 31e, 32e, respectively, of the coils 11 in the second group (2). Also included are crank-shaped wiring traces 53 that connect the first-end electrodes 33e of the coils 11 in the second group (2) with the first-end electrodes 31e of the coils 11 in the third group (3). In FIG. 13, the wiring traces 51, 52, 53 used to connect the coils 11 energized with U-phase power in the second and third groups are shaded for clarity.

The wiring traces 51, 52, 53 desirably are made of thin films of conductive material (e.g., copper foil) formed on an insulative sheet 17 (see FIG. 4). The wiring traces 51-53 desirably are covered by an insulative film. The insulative film is not present on the ends 55, 56 of the wiring traces 51, 52, respectively, and on the ends 57, 58 of the wiring trace 53. In other words, the ends 55, 56, 57, 58 are exposed electrodes. The ends 55, 56 are termed “third electrodes” and the ends 57, 58 are termed “fourth electrodes.”

The first-end electrodes 32e, 33e of the coils 11 in the third group (3) connected to the wiring traces 51, 52, respectively, desirably are covered by the insulative film. In other words, in the third group (3), the connection between each of the partial coils 22 and the respective wiring trace 51 is insulated and the connection between each of the partial coils 23 and the respective wiring trace 52 is insulated. In the third group (3), the first-end electrode 31e of each of the partial coils 21 is not insulated. In the second group (2), all of the first-end electrodes 31e, 32e, 33e are not insulated.

The wiring traces 51 extend diagonally from respective first-end electrodes 32e of the coils in the third group (3). The third electrodes 55 on the respective wiring traces 51 are vertically aligned (in FIG. 13) with respective first-end electrodes 31e of coils in the second group (2). The distance Z₁ between each third electrode 55 and the corresponding first-end electrode 31e is four times an inter-fold distance D₂ (discussed later below).

The wiring traces 52 extend diagonally from respective first-end electrodes 33e of the coils in the third group (3). The third electrodes 56 on the respective wiring traces 52 are vertically aligned (in FIG. 13) with respective first-end electrodes 32e of coils in the second group (2). The distance between each third electrode 56 and the corresponding first-end electrode 32e is equal to Z₁.

Each wiring trace 53 extends between respective fourth electrodes 57, 58. Each fourth electrode 57 is vertically aligned (in FIG. 13) with a respective first-end electrode 31e of coils in the second group (2). The distance between each fourth electrode 57 and the corresponding first-end electrode 31e is equal to Z₁. Also, the distance Z₂ between each fourth electrode 58 and the corresponding first-end electrode 31e is equal to six times the inter-fold distance D₂. The distance Z₁ is a 2n multiple (i.e., even-number multiple) of the distance D₂, and the distance Z₂ can be a (2n+2) multiple or an even-numbered multiple of 2 n or greater of the distance D₂.

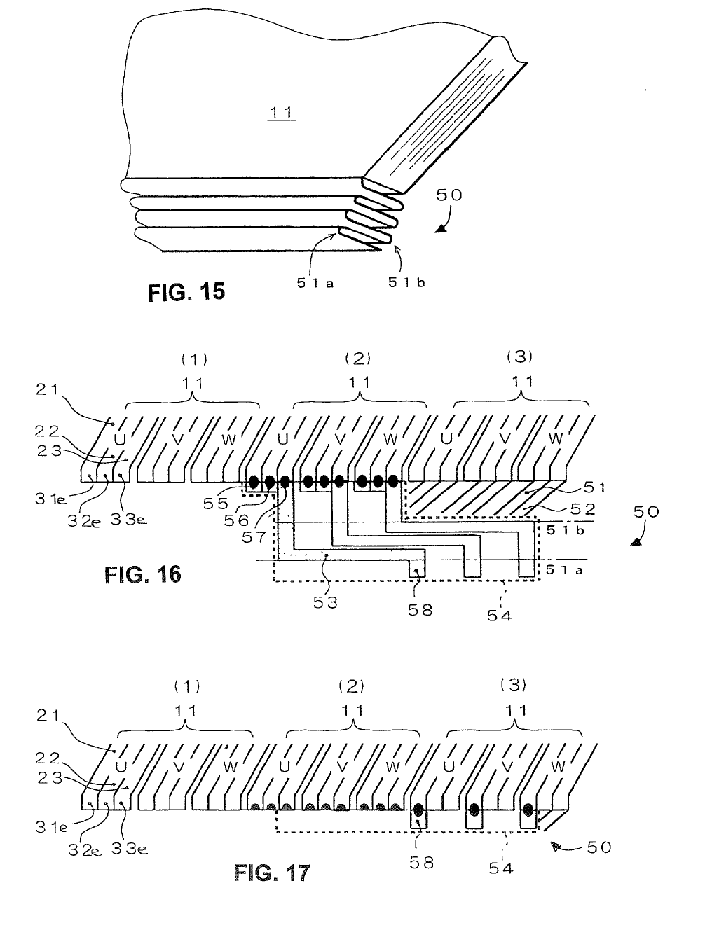

Mountain folds 50a (denoted by dot-dot-dash lines) and valley folds 50b (denoted by dot-dash lines) extend in alternating order across the connector unit 50. The folds 50a, 50b are parallel with the folds 12a, 12b extending across the wiring traces 14-16 (FIG. 3). The folds 50a, 50b are spaced apart from each other by the distance D₂, which is termed an “inter-fold distance.” During folding of the connector unit 50, the mountain folds 50a and the valley folds 50b are folded alternately in a pleat manner (see FIG. 15).

As the connector unit 50 is being folded as described above, two soldering steps are added. The first soldering step is performed after the wiring traces 51, 52 of the connector unit 50 are folded (FIG. 16). The first soldering step connects the third electrodes 55, 56 of the wiring traces 51, 52, respectively, with the respective first-end electrodes 31e, 32e of the coils in the second group, and connects the fourth electrodes 57 of the wiring traces 53 with the respective first-end electrode 33e of the coils in the second group. The second soldering step is performed after the wiring traces 53 of the connector unit 50 are folded (FIG. 17). The second soldering step connects the fourth electrodes 58 of the wiring traces 53 with the respective first-end electrodes 31e of the coils in the third group. Thus, each partial coil 21 in the second group is connected to the respective partial coil 22 in the third group via a respective wiring trace 51 (31e to 32e). Also, each partial coil 22 in the second group is connected to the respective partial coil 23 in the third group via a respective wiring trace 52 (32e to 33e). In addition, each partial coil 23 in the second group is connected to the respective partial coil 21 in the third group via a respective wiring trace 53 (33e to 31e).

Meanwhile, the connector unit 60 (FIG. 14) is used to connect coils 11 of the second group (2) with coils 11 of the first group (1). The coils are connected such that second-end electrodes 41e, 42e, 43e in the first group are connected to second-end electrodes 42e, 43e, 41e, respectively, in the second group (i.e., 41e to 42e, 42e to 43e, and 43e to 41e, see FIG. 11).

The connector unit 60 shown in FIG. 14 has the same basic structure as the connector unit 50, including the linear wiring traces 51, 52 and crank-shaped wiring traces 53. In the connector unit 60, however, each wiring trace 51 is connected to a respective second-end electrode 42e of a respective partial coil 22 in the first group (1) of coils, and each wiring trace 52 is connected to a respective second-end electrode 41e of a respective partial coil 23 in the first group. The third electrode 55 of each wiring trace 51 is vertically aligned (in FIG. 14) with the corresponding second-end electrode 43e in the second group of coils. The third electrode 56 of each wiring trace 52 is vertically aligned (in FIG. 14) with the corresponding second-end electrode 42e in the second group of coils. With respect to each wiring trace 53, the fourth electrode 57 is vertically aligned (in FIG. 14) with the corresponding second-end electrode 41e in the second group of coils, and the fourth electrode 58 is vertically aligned (in FIG. 14) with the corresponding second-end electrode 43e in the second group.

As the wiring traces 51, 52 of the connector unit 60 are folded (as shown in FIG. 16), first and second soldering steps are performed. In the first soldering step, the third electrodes 55, 56 of each of the wiring traces 51, 52 are connected to the corresponding second-end electrodes 43e, 42e, respectively, of the coils in the second group. Also, the fourth electrodes 57 of each of the wiring traces 53 are connected to the respective second-end electrodes 41e of the coils 11 in the second group. The second soldering step is performed after folding the wiring traces 53 of the connector unit 60 (see FIG. 17), and results in connection of the fourth electrodes 58 of each of the wiring traces 53 with respective second-end electrodes 43e of the coils of the first group.

Thus, with respect to the coils in the first and second groups, each partial coil 22 of the first group is connected to a respective partial coil 23 of the second group via a respective wiring trace 51 (42e to 43e). Also, each partial coil 21 of the first group is connected to a respective partial coil 22 of the second group via a respective wiring trace 52 (41e to 42e). Also, each partial coil 23 of the first group is connected to a respective partial coil 21 of the second group via a respective wiring trace 53 (43e to 41e).

With this embodiment, by simply folding the sheet-coil substrate, on which the connector units 50, 60 are formed, in a pleated manner, it is possible to make the required interconnections between coils such that all connection points within each group are shifted by one partial coil. These interconnections are easy to make and reduce the number of soldered joints by about half, compared to conventional sheet coils. Also, the pleated folds simplify the positioning of electrodes for soldering.

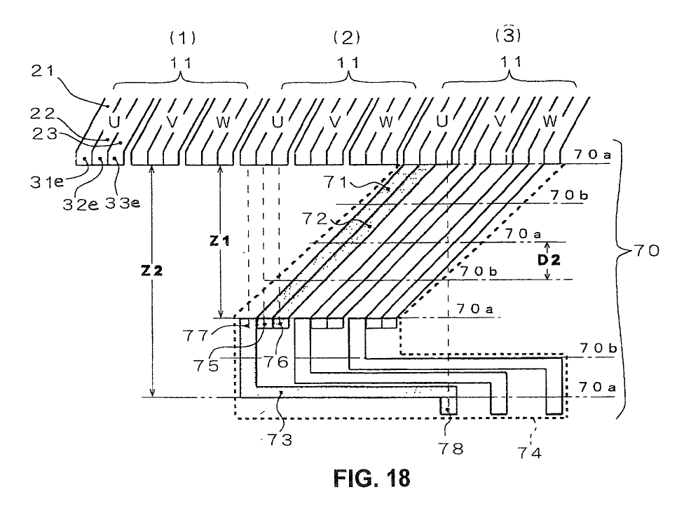

In this embodiment as described above, the connector units 50, 60 are used for making the following connections: 41e to 42e, 42e to 43e, 43e to 41e, 31e to 32e, 32e to 33e, and 33e to 31e. Alternatively, a connector unit 70 as shown in FIG. 18 can be used to make connections in which the order is reversed, namely: 41e to 43e, 42e to 41e, 43e to 42e, 31e to 33e, 32e to 31e, and 33e to 32e. The connector unit 70 includes wiring traces 71, 72, 73 that are similar to the respective wiring traces 51, 52, 53 of the connector units 50 and 60. However, each wiring trace 71 is connected to the first-end electrode 31e of the respective partial coil 21 of the third group, and each wiring trace 72 is connected to the first-end electrode 32e of the respective partial coil 22 of the third group. Also, the third electrode 75 of each wiring trace 71 is vertically aligned (in FIG. 18) with the respective first-end electrode 32e of coils in the second group, and the third electrode 76 of each wiring trace 72 is vertically aligned (in FIG. 18) with the respective first-end electrode 33e of coils in the second group. With respect to the wiring traces 73, each fourth electrode 77 is vertically aligned (in FIG. 18) with the respective first-end electrode 31e of coils in the second group, and each fourth electrode 78 is vertically aligned (in FIG. 18) with the respective first-end electrode 33e of coils in the third group. By folding the connector unit 70 in a pleated manner, each partial coil 22 of the second group is connected to the respective partial coil 21 of the third group via a respective wiring trace 71 (32e to 31e). Also, each partial coil 23 of the second group is connected to the respective partial coil 22 of the third group via a respective wiring trace 72 (33e to 32e). Also, each partial coil 21 of the second group is connected to the respective partial coil 23 of the third group via a respective wiring trace 73 (31e to 33e).

### Fourth Representative Embodiment

Similar to the sheet coil 10 of the first representative embodiment, a sheet coil according to this embodiment can be incorporated into the armature of a moving-coil type three-phase linear motor. The sheet coil of this embodiment differs from that of the first representative embodiment (FIGS. 1-9) mainly in the configuration of connections between the coils. Other structures (including the structures of the coils 11 themselves and the number of coils 11) are the same as in the sheet coil 10 of the first representative embodiment. These similar structures are not described further below.

When supplying three-phase (U phase, V phase, and W phase) AC current to the sheet coil of this embodiment, the six coils 11 are divided into three groups of two coils 11 each. Serial electrical connections are made for the partial coils of each group. Each coil 11 of a group (e.g., the U-phase group) is interspersed with the coils 11 of the other two groups (i.e., the V-phase group and the W-phase group, see FIG. 5).

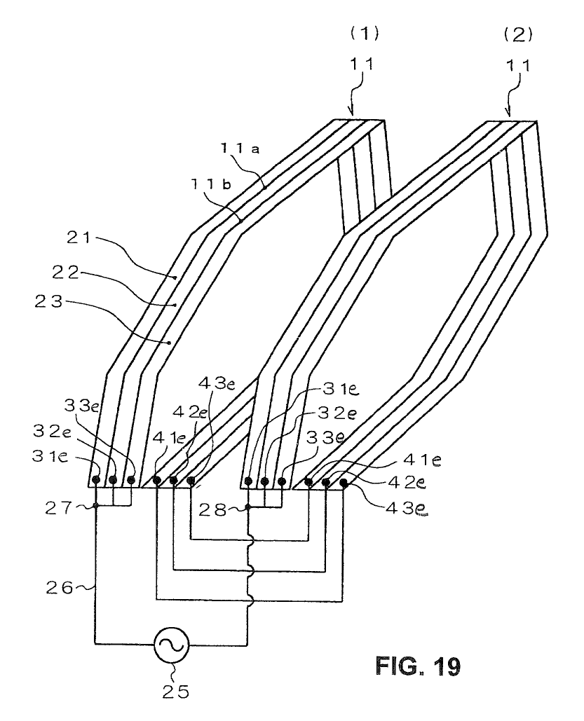

Turning now to FIG. 19, the interconnection of the two coils 11 of a group is performed using the first-end electrodes 31e, 32e, 33e and the second-end electrodes 41e, 42e, 43e. Only the interconnections for one group are shown in FIG. 19, in which each coil 11 is simplified by the depiction of only one turn of the coil. Also, the first-end electrodes 31e, 32e, 33e and second-end electrodes 41e, 42e, 43e are laterally shifted in the figure for clarity. In each group, one of the two coils 11 (e.g., the left-hand coil 11 in FIG. 19) is denoted the “first coil 11” and the other coil (the right-hand coil 11) is denoted the “second coil 11.”

The coils in FIG. 19 are energized by an AC-current supply 25 providing the respective phase (U phase, W phase, or V phase). The AC supply is connected between the first-end electrodes 31e, 32e, 33ₑ of the first coil 11 and the first-end electrodes 31e, 32e, 33e of the second coil 11.

In the connections of the second-end electrodes 41e, 42e, 43e of the first coil 11 with the second-end electrodes 41e, 42e, 43e of the second coil 11, the second-end electrode 41e of the first coil 11 is connected to the second-end electrode 43e of the second coil 11 (41e to 43e). Also, the second-end electrode 42e of the first coil 11 is connected to the second-end electrode 42e of the second coil 11 (42e to 42e), and the second-end electrode 43e of the first coil 11 is connected to the second-end electrode 41e of the second coil 11 (43e to 41e).

For each of the other two groups of coils not shown in FIG. 19, the first coil 11 and second coil 11 are connected in the same manner as shown in FIG. 19. The coils are energized with AC current of the respective phase. The three phases U, V, W differ from each other by 120°.

During operation of a moving-coil type three-phase linear motor including the sheet coil of this embodiment, the sheet coil (incorporated into an armature) moves relative to the magnetic field (having a cyclical distribution of magnetic flux) formed by the stator. As a result, the instantaneous rate of change of the stator magnetic flux Φ “seen” by each partial coil 21, 22, 23 changes according to the position of the respective partial coil 21-23 relative to the magnetic fields produced by the stator. A different counter-EMF E is generated for each of the partial coils 21, 22, and 23 in each coil (E₁≠E₂≠E3).

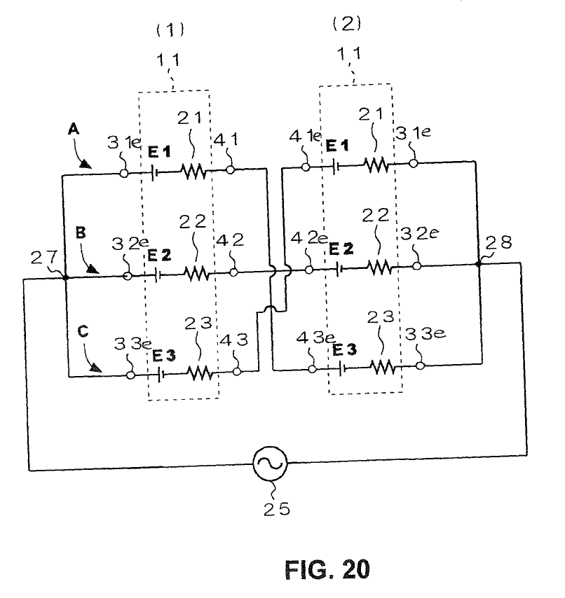

When considering the counter-EMFs E₁, E₂, E₃ generated at the partial coils 21, 22, 23 of each coil 11, an equivalent circuit for each group of coils of this embodiment can be depicted as shown in FIG. 20. In FIG. 20, characteristic of each group of sheet coils of this embodiment, three paths A, B, C are connected in parallel, and the circuit is closed by connecting the connection points 27, 28 to the AC supply 25.

Path A comprises a serial connection between the partial coils 21 and 23. With respect to path A, a counter-EMF E₁ is generated for the partial coil 21 and a counter-EMF E₃ is generated for the partial coil 23. Hence, the sum of these counter-EMFs for path A is ΣEₐ=E₁+E₃. Path B comprises a serial connection between the partial coils 22 and 22. With respect to path B, a respective counter-EMF E₂ is generated for each of the two partial coils 22. Hence, the sum of these counter-EMFs for path B is ΣE_{b}=E₂+E₂. Path C comprises a serial connection between the partial coils 23 and 21. With respect to path C, a counter-EMF E₃ is generated for the partial coil 23, and a counter-EMF E₁ is generated for the partial coil 21. Hence, the sum of these counter-EMFs for path C is ΣE_{c}=E₃+E₁.

As described above, the respective counter-EMFs E₁, E₂, E₃ generated at the partial coils 21, 22, 23, respectively, are not the same (i.e., E₁≠E₂≠E₃). The sum of the counter-EMFs at path A (ΣEₐ) and the sum of the counter-EMFs at path C (ΣE_{c}) are averaged and thus equalized (ΣEₐ=ΣE_{c}). Meanwhile, the sum of the counter-EMFs at path B (ΣE_{b}) is different from the sum of the counter-EMFs at path A (ΣEₐ) or the sum of the counter-EMFs at path C (ΣE_{c}) (i.e., ΣEₐ≠ΣEE_{b} and ΣE_{c}≠ΣE_{b}).

The half cycle of the distribution of magnetic flux density formed by the stator of the three-phase linear motor of this embodiment is about equal to the distance in the array direction between the individual coils 11 of each group. Hence, the periodicity of the distribution of the magnetic flux density formed by the stator is reflected in the respective magnitudes of the counter-EMFs E₁, E₂, E₃ generated at the partial coils 21, 22, 23, respectively, and an approximation of E₁+E₃≈E₂+E₂≈E₃+E₁ is established. Therefore, the electric-potential differences between the parallel paths A, B, C are extremely small. Even if a loop current I_{b} flows through the closed circuit via the connection points 27, 28, the magnitude of this loop current is extremely small.

Whenever a sheet coil according to this embodiment moves relative to a cyclical distribution of magnetic flux produced by a stator, an eddy current Iₐ is generated at each coil 11. However, each coil 11 includes two slits 11a, 11b dividing the coil into three respective partial coils 21, 22, 23. The width of the conductor in each partial coil is narrow (yielding high resistance). Hence, the eddy current Iₐ generated at each partial coil 21, 22, 23 is reduced compared to conventional devices (see FIG. 8).

As a result of the foregoing, in a sheet coil according to this embodiment, an extremely small loop current I_{b} is produced. The viscous resistance produced by such a small loop current I_{b} also is extremely small. Also, because the eddy current Iₐ is small, the associated viscous resistance also is small.

FIG. 10 shows a comparison of the viscous resistance (b) produced by the sheet coil 10 of the first representative embodiment with the viscous resistance (c) produced by the sheet coil of this embodiment. From the plots (b) and (c), it can be seen that the viscous resistance (c) is about 1/10 the viscous resistance (b).

A sheet coil of this embodiment was described above in a context in which each coil 11 included two slits 11a, 11b dividing the coil 11 into three partial coils 21, 22, and 23. It will be understood that this embodiment is not limited to a configuration in which the number of partial coils (n) of each coil is n=3 (with a slit count of n−1=2). In general, the number of partial coils per coil is n≧2. Any of these configurations produces small eddy currents Iₐ and small loop currents I_{b}. In making a decision as to the number of slits per coil, it is possible, according to this embodiment, to consider the desired performance of the linear motor. Motor performance is determined by factors such as restrictions on viscous resistance and operating temperature. Thus, an optimal number of partial coils per coil and an optimal number of slits (n−1) can be specified according to the desired performance.

For example, consider a case in which each coil 11 is divided into n partial coils. With each group of coils of this embodiment, a closed loop in which n paths (A, B, C, . . . ) are connected in parallel is formed (an equivalent circuit is shown in FIG. 20). With respect to the n partial coils, unequal counter-EMFs E₁, E₂, E₃, . . . Eₙ are generated. With the coil-interconnection scheme of this embodiment, different respective counter-EMFs generated at each partial coil can be averaged. As a result, the sum of the counter-EMFs at the n paths A, B, C, . . . (ΣEₐ, ΣE_{b}, ΣE_{c}, . . . ) are (E₁+Eₙ), (E₂+Eₙ₋₁), (E₃+E₋₂), . . . , (Eₙ₋₁+E₂), and (Eₙ+E₁) are approximately equal to each other.

The sheet coil of this embodiment, as described above, included two coils 11 per group. In general, the number of coils 11 per group desirably is an even integer m. With such a configuration, it is possible to average the different counter-EMFs generated at each partial coil in an efficient manner. Alternatively, the number of coils per group can be an odd integer.

If the number of coils 11 per group is greater than 2 (i.e., if m>2), then the sums ΣEₐ, ΣE_{b}, ΣE_{c}, . . . Eₙ of the respective counter-EMFs of the n paths (A, B, C, . . . ) are (E₁+Eₙ+E₁+E_{N}+. . . ), (E₂+Eₙ₋₁+E₂+Eₙ₋₁+ . . . ), (E₃+Eₙ₋₂+E₃+Eₙ₋₂ . . . ), . . . (Eₙ₋₁+E₂+Eₙ₋₁+E₂ . . . ), and (Eₙ+E₁+Eₙ+E₁ . . . ).

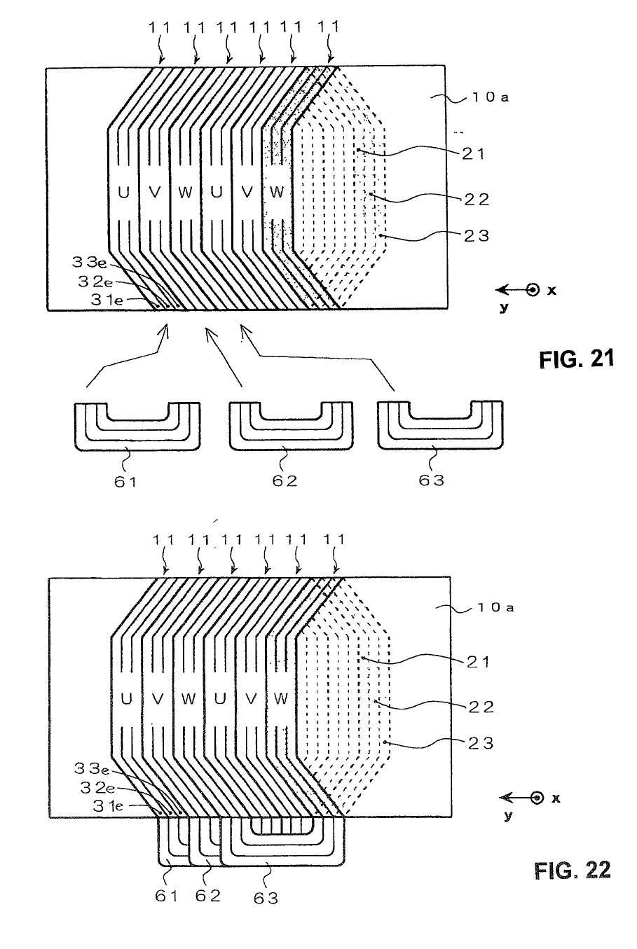

In the sheet coil of this embodiment, the connections between the coils 11 of different groups were made using copper wires 26. Alternatively, it is possible to use the three connector units 61, 62, 63 shown in FIG. 21 for making connections between the coils. Similar to the connector unit 50 (FIG. 13), the connector units 61, 62, 63 desirably are configured as traces of conductive material formed on an insulative sheet. The coils 11 in the U-phase group are connected together serially by the connector unit 61, the coils 11 in the V-phase group are connected together serially by the connector unit 62, and the coils 11 in the W-phase group are connected together serially by the connector unit 63 (FIG. 22).

Although this embodiment was described in connection with using the sheet coil in a moving-coil type of linear motor, it alternatively is possible to use the sheet coil in a moving-magnet type of linear motor.

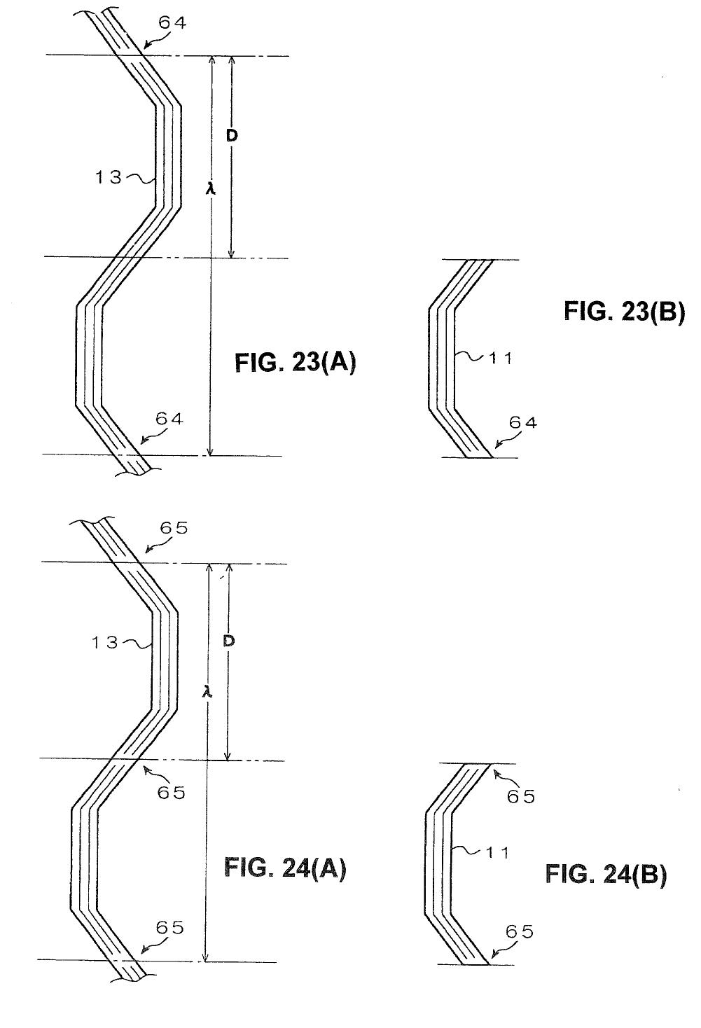

With respect to the first representative embodiment as described above, there was a complete separation of partial coils 21, 22, 23 from each other due to the slits 11−a, 11b. As a result, each first end 31, 32, 33 was connected only to a respective second end 41, 42, 43 via the respective partial coil 21, 22, 23. Similarly, each first end 35, 36, 37 was connected only to a respective second end 45, 46, 47 of a wiring-trace pattern 13. However, the invention is not so limited. For example, as shown in FIGS. 23(A)-23(B), it is possible to provide a “linking unit” 64 at every cycle λ of the wiring-trace pattern 13 (FIG. 23(A)) and the coil 11 (FIG. 23(B)). Alternatively, as shown in FIGS. 24(A)-24(B), it is possible to provide a “linking unit” 65 at every half cycle λ/2 of the wiring-trace pattern 13 (FIG. 24(A)) and the coil 11 (FIG. 24(B)). In the configurations of FIGS. 23(A)-23(B) the eddy currents are small. But, the effect achieved in this configuration is less than achieved in the configuration shown in the right-hand portion of FIG. 8.

Additional approaches can be used for further reducing “eddy-current feed back” from one of the traces to the others. In FIG. 9(A), all traces are tied together, at the right end in the figure, at the point 28 and, at the left end in the figure, at the point 27. By opening at least one of these common connections 27, 28 to allow current to be fed independently to each trace, no eddy-current feed back occurs. For example, in FIG. 9(B), items 25A, 25B, and 25C are respective current drives that provide electrical current according to respective commands from the system controller. The current drives 25A, 25B, 25C do not change their output current if their output voltage fluctuates. Hence, as the voltage output of E1, E2, and/or E3 changes, no change occurs in the electrical current delivered to the respective traces.

Another approach for isolating changes in E1, E2, and/or E3 from causing eddy-current feed back is to use additional resistance in series with each trace, as exemplified by the scheme shown in FIG. 9(C). This scheme is especially usable if respective voltage variations in E1, E2, and/or E3 are small. In FIG. 9(C), the drive source 25 can be a current or voltage drive. The resistors 21A, 22B, 23C are located away from the motor. The resistance values are selected to allow E1, E2, E3 voltage variations to have only a negligible effect on the system. Since the resistors 21A, 22B, 23C are not part of the winding, they can be located away from heat-sensitive components. This scheme of adding remote resistors effectively adds to the respective resistances 21, 22, and 23 without adding heat to the motor.

With respect to the first through fourth representative embodiments as described above, a folded-type sheet coil is produced by folding one sheet-coil substrate into pleats. Alternatively, it is possible to use a multi-layered type of sheet coil produced by laminating together multiple sheet-coil substrates (each substrate representing a respective half cycle of a wiring pattern). With such a multi-layered configuration, it is possible to omit the insulative film covering the wiring-trace pattern 13 in FIG. 3.

Further with respect to the first through fourth representative embodiments, the bottoms of the slits 13a, 13a extended to the insulative sheet 17 (FIG. 3). Under certain conditions it is acceptable to have the bottoms of the slits 13a, 13a not quite reach the insulation sheet 17, resulting in slight interconnection between adjacent coil portions in the space between the bottoms of the slits and the insulative substrate. This allows manufacturing tolerances to be relaxed. Referring to FIG. 4, this alternative configuration can be used whenever the distance w₂ between connectors 14 and 15 and between conductors 15 and 16 is relatively narrow. Under these conditions, coil resistance is low and coil heating is low. If a slight interconnection is left between adjacent conductors 14 and 15 and between adjacent conductors 15 and 16, the resistance between the adjacent conductors is adequately high to provide acceptable electrical insulation between them. However, the spaces (having distance w₁) between conductors 14 and 16 still desirably have no residual interconnecting conductor.

### Fifth Representative Embodiment

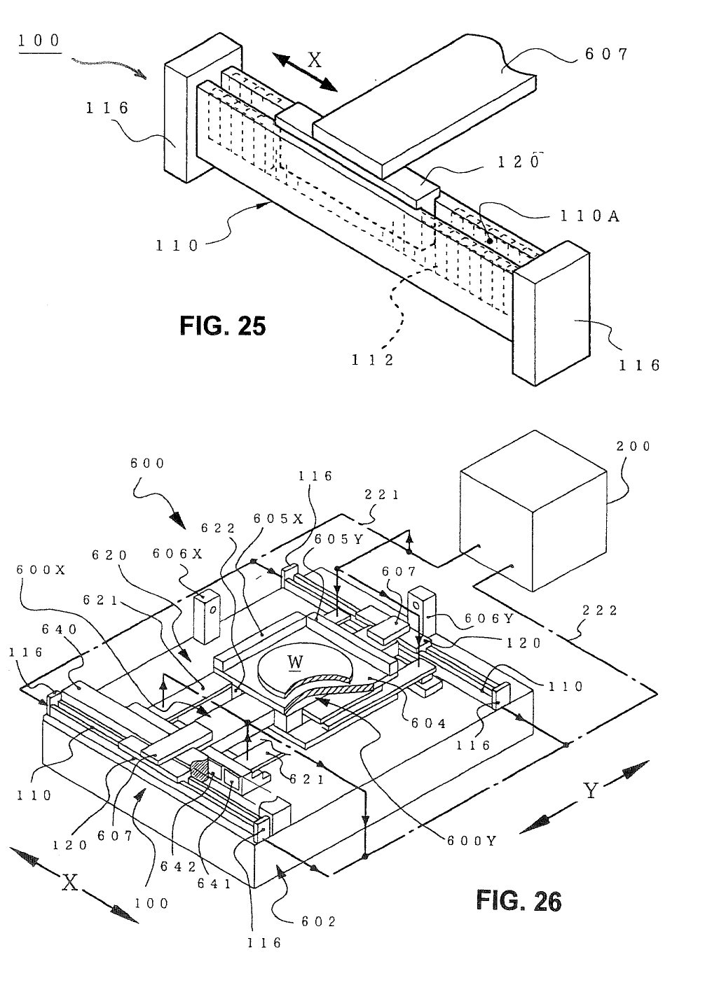

This embodiment is directed to linear motors 110 comprising a moving component (armature) 120 including a sheet coil according to the invention, such as described in any of the first through fourth representative embodiments. As shown in FIG. 25, the linear motor 100 of this embodiment comprises a static component (stator) 110. The stator 110 can be mounted to a base 602 (FIG. 26) of a stage unit 600 by support members 116. In this configuration the armature 120 can be mounted to a movable stage 607. The stator 110 has a U-shaped transverse section that defines a longitudinal slot 110A, and the armature 120 has a T-shaped transverse section. The stem of the T of the armature 120 is inserted into and slides freely in the slot 110A in the longitudinal direction.

The stator 110 comprises multiple permanent magnets 112 arranged (“stacked”) along the longitudinal direction. The magnets 112 thus form the walls of the slot 110A of the stator 110, and form the cyclic distribution of magnetic flux density produced by the stator 110.

As noted above, the armature 120 comprises a sheet coil such as any of the sheet coils of the first through fourth representative embodiments. In the armature 120, the sheet coil is sheathed with a jacket (housing; not detailed). The jacket defines a flow path (not shown) for a cooling medium (coolant). Thus, the sheet coil is cooled by a cooling medium delivered through conduits 221, 222 from a cooling device 200 (FIG. 26). The sheet coil is connected electrically to a driving circuit (not shown, but see descriptions above) that supplies AC electrical power to the coils, as described above.

In the linear motor, the armature 120 moves along a respective dimension relative to the respective stator 110. For example, in FIG. 26, one linear motor 100 provides armature movement in the X-direction, and another linear motor 620 provides armature movement in the Y-direction. In any event, during such linear movement of the armature 120, the viscous resistance imparted to the armature 120 is reduced compared to conventional linear motors, thereby yielding less reduction in drive force experienced by the armature.

### Sixth Representative Embodiment

This embodiment is directed to stage units 600 comprising at least one linear motor 100 such as described in the fifth representative embodiment. The stage unit 600 generally is used in connection with an apparatus employed for semiconductor fabrication or other process. As noted above, the linear motor 100 is especially advantageous for such use because the motor exhibits reduced viscous resistance imparted to the armature 120, yielding less reduction in armature-drive force than in conventional linear motors.

An exemplary stage unit 600 is shown in FIG. 26, which comprises two parallel linear motors 100 used for moving a body 604 in the X-direction, and two parallel linear motors 620 for moving the body 604 in the Y-direction. Actually, the linear motors 100 move an “X-direction stage” 600X (comprising the body 604 and the linear motors 620) in the X-direction, and the linear motors 620 move a “Y-direction stage” 600Y in the Y-direction. The linear motors 100, 620 are as described above, and are not described further. The body 604 can be, for example, a stage for holding a wafer or other substrate W during microlithographic exposure in which a pattern, defined by a reticle or mask, is transferred to the substrate W.

More specifically, the stage unit 600 as shown in FIG. 26 is a two-axis (X-axis and Y-axis) X-Y movable stage that includes the X-direction stage 600X and the Y-direction stage 600Y. The X-direction stage 600X is movable in the X-direction (indicated by the arrow X in the figure) relative to the base 602. The Y-direction stage 600Y is movable in the Y-direction (indicated by the arrow Y in the figure) relative to the base 602. Thus, the body 604 is movable by the stages 600X, 600Y in the X- and Y-directions, respectively, relative to the base 602. The body 604 is mounted on the Y-direction stage 600Y, and the substrate W is mounted to the body 604 by a wafer holder or chuck (not shown, but well understood in the art). For microlithography, a microlithographic-optical system (not shown, but well-understood in the art) is situated over the substrate W so as to achieve transfer of a pattern to the substrate W. So as to be imprinted with the pattern, the upstream-facing surface of the substrate W is coated with an exposure-sensitive material (“resist”).

Respective movements of the X-direction stage 600X and Y-direction stage 600Y relative to the base 602 usually are measured interferometrically to provide the required measurement accuracy. Respective laser interferometers 606X, 606Y are used, each directing measurement light to respective moving mirrors 605X, 605Y mounted on the X-direction edge and Y-direction edge, respectively, of the body 604. The laser interferometers 606X, 606Y are mounted to the base 602 such that light from the respective interferometers impinge on the respective moving mirrors 605X, 605Y. A controller (computer, not shown but well understood in the art) is used to control movements of the body 604 as effected by the linear motors 100, 620, based on various data input to the controller, including data from the interferometers 606X, 606Y.

Each of the linear motors 100 includes a respective stator 110 and armature 120 as described above. The armatures 120 each include a sheet coil as described above. The respective stators 110 are attached via respective support members 116 to the base 602, and the respective armatures 120 are attached to the X-direction stage 600X by respective mounting plates 607.

Each of the linear motors 620 includes a respective stator 621 and armature 622 as described above. The armatures 622 each include a sheet coil as described above. The respective stators 621 are attached to the X-direction stage 600X, and the respective armatures 622 (only one is shown) are attached to the Y-direction stage 600Y.

As mentioned in the fifth representative embodiment, each stator 110, 621 is cooled by a cooling medium that circulates through conduits 221, 222 to and from a temperature-regulated cooling device 200.

The stage unit 600 also comprises a pneumatic bearing 640 as well understood in the art. The pneumatic bearing 640 includes an air-inlet port 642 and an air-outlet port 641.

### Seventh Representative Embodiment

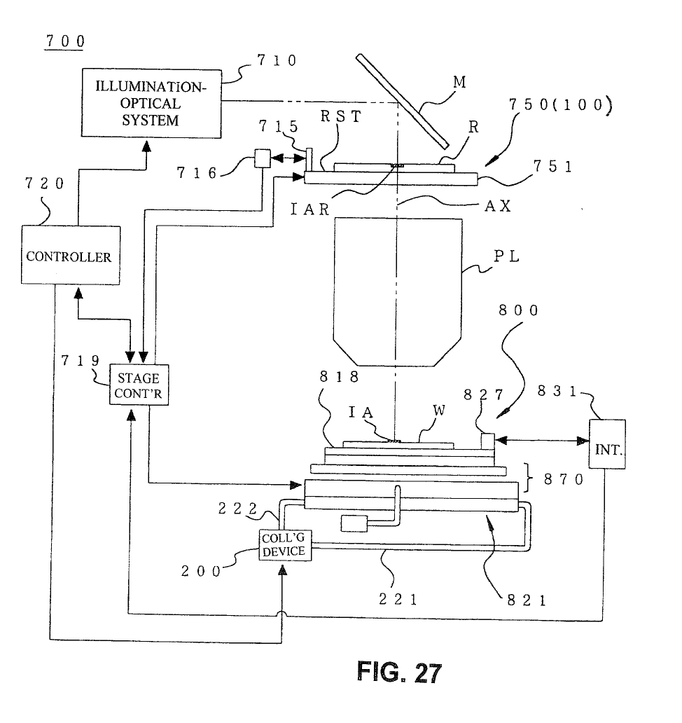

This embodiment, shown in FIG. 27, is directed to a microlithography apparatus 700 comprising a stage (e.g., reticle stage 750) including linear motors 100 each configured as described, for example, in the fifth representative embodiment. The apparatus 700 is a so-called “step-and-scan” projection-exposure device.

The apparatus 700 comprises an illumination-optical system 710 situated on an axis AX upstream of a reticle R, and a projection-optical system PL situated on the axis AX downstream of the reticle R but upstream of a substrate W that is imprinted with a pattern defined by the reticle. The reticle R is mounted to the reticle stage 750 that includes a reticle-stage base 751. The apparatus also includes a substrate stage 800 on which the substrate W is mounted. The substrate stage 800 moves the substrate W in X-and Y-directions within an X-Y plane. A controller 720 controls operation of the various components in the apparatus 700. The illumination-optical system 710 illuminates a beam of exposure light, from a light source (not shown but well understood in the art) at a uniform illumination intensity onto an illumination area IAR on the reticle R. The reticle stage 750 is movable, relative to the base 751, along a guide rail (not shown but well understood in the art) at a designated scan velocity during exposure. Meanwhile, the reticle R is fixed by vacuum suction, for example, on the upper surface of the reticle stage 750. Illumination light passing through the illumination area IAR on the reticle (this light now is termed “imaging light”) passes through an aperture in the reticle stage 750 to the projection-optical system PL.

The movement position of the reticle stage 750 is detected interferometrically using a moving reflective mirror 715 and a laser interferometer 716. A stage controller 719 drives the reticle stage 750 according to data and electrical commands from the controller 720, as affected by positional data provided by the laser interferometer 716.

The projection-optical system PL is a “reduction” or “demagnifying” optical system. The axis AX extending through the projection-optical system PL extends along a Z-direction in the figure. The projection-optical system PL typically comprises multiple lens elements placed at designated intervals along the optical axis AX. Hence, whenever the illumination area IAR of the reticle R is illuminated by the illumination-optical system 710, a reduced and inverted image of the illumination area is formed on an exposure area IA on the substrate W. The plane of the exposure area IA is conjugate with the plane of the illumination area IAR on the reticle R.

The substrate stage 800 includes a substrate-mounting table 818 that is actuated by a planar motor 870 for movement in the X-Y plane. Specifically, the substrate stage 800 comprises a base 821 above which the substrate-mounting table 818 “floats” with a clearance of a few μm. For exposure, the substrate W is mounted to the table 818 by vacuum suction, for example. A moving mirror 827 is mounted to the substrate-mounting table 818. A laser beam from an interferometer 831 is irradiated onto the moving mirror 827 to achieve monitoring of the movement position of the table 818 within the X-Y plane. Positional data produced by the interferometer 831 is routed to the controller 720, which controls the position of the table 818 via a stage controller 719. I.e., based on this data, the stage controller 719 actuates the planar motor 870 to move the table 818 to a desired position in the X-Y plane according to instructions from the controller 720.

The table 818 is supported at three different points by a support mechanism (not shown but well understood in the art) extending between the underside of the table 818 and the upper surface of a moving component (not shown) of the planar motor 870. Using the planar motor 870, the table 818 not only can be driven in the X-and Y-directions but also can be tilted as required relative to the X-Y plane or driven in the Z-direction (vertically in the figure). Because the planar motor 870 has a structure that is known in the art, further explanations of this component are not provided herein.

The base 821 is cooled by coolant fluid delivered by a temperature-regulated cooling device 200. The coolant is delivered to the base and removed from the base by conduits 221, 222, respectively.

Using the apparatus shown in FIG. 27, microlithographic exposure of the substrate W occurs using the following procedure:

First, the reticle R and the substrate W are loaded onto their respective stages 750, 800. Afterward, reticle alignments, baseline measurements, and alignment measurements, etc., are executed. After completing the alignment measurements, the substrate W is exposed using, for example, the step-and-scan exposure method.

For exposure, the controller 720 outputs commands to the stage controller 719, based on data concerning position of the reticle R (from the reticle-position interferometer 716) and position of the substrate W (from the substrate-position interferometer 831). The stage controller 719 causes the linear motor 100 of the reticle stage 750 and the planar motor 870 of the substrate stage 800 to the move the reticle R and wafer W in a synchronous manner. Thus, a desired scanning exposure is performed.

Whenever transfer of a reticle pattern to one “die” or “chip” area on the substrate is completed, the table 818 is stepped by one die or chip to allow exposure of the next die or chip. This scheme is termed “step-and-scan” exposure, and is performed multiple times over the surface of the substrate W to achieve the desired number of die or chip exposures on the substrate W.

The reticle stage 750 comprises multiple linear motors 100 as described above. Each linear motor 100 has an armature with a sheet coil, as described above. Three-phase current is supplied as appropriate to the respective sheet coils to achieve a desired and controlled movement of the reticle R. Meanwhile, the linear motors 100 are cooled as described above.

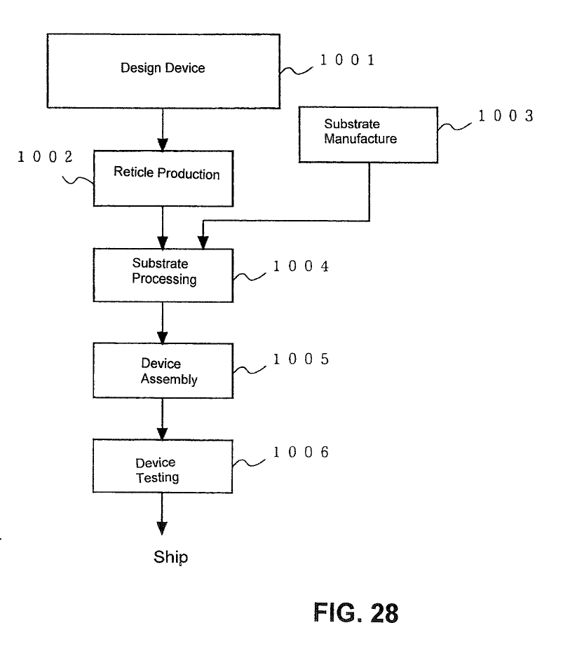

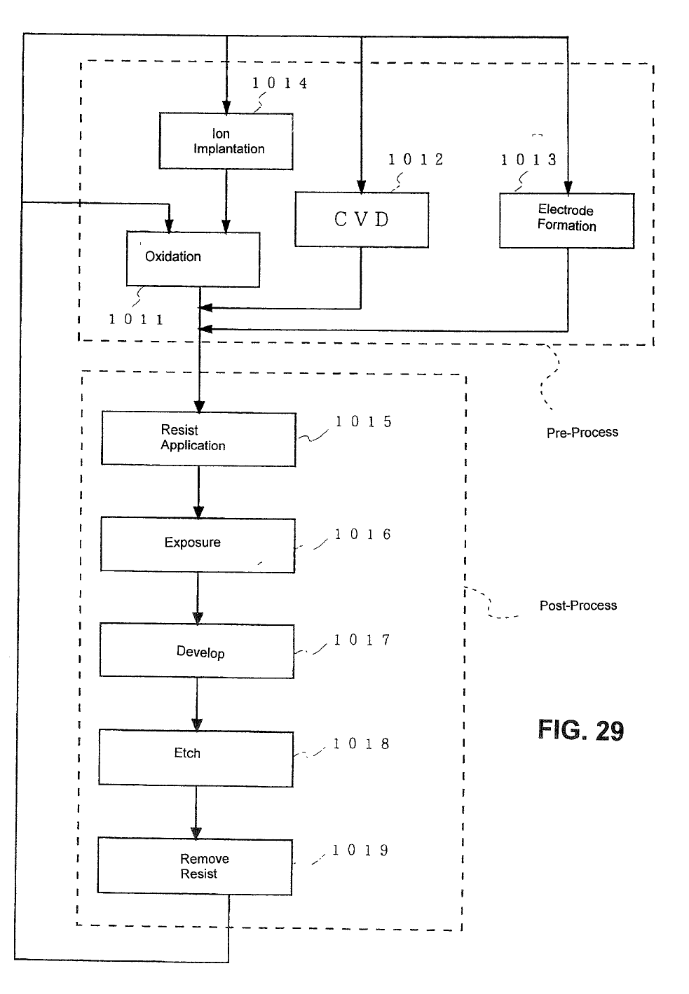

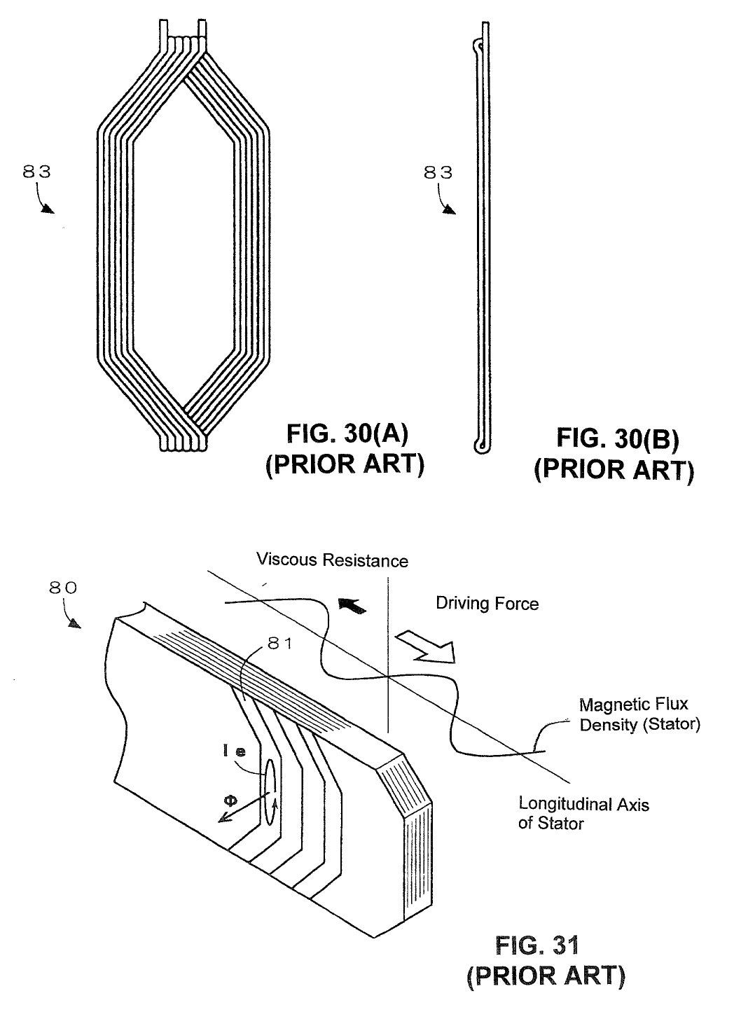

Fabrication of microelectronic devices using the stage unit 600 of the sixth representative embodiment and the microlithography apparatus 700 of the seventh representative embodiment can be performed using a process as depicted in FIGS. 28 and 29.

Principal steps of the process include (a) designing the device, including its functions and performance; (b) producing a reticle that defines a pattern for the device; (c) producing a suitable substrate (e.g., semiconductor wafer); (d) microlithographically transferring the reticle pattern to the substrate using the apparatus 700 of the seventh representative embodiment; (e) executing a device-assembly step including dicing, bonding, and packaging (including the dicing process, bonding process, and packaging process); and (f) a device-testing step. An exemplary process is depicted in FIG. 28, as used for fabricating a microelectronic device (e.g., a semiconductor chip such as an integrated circuit or LSI device, a display such as a liquid-crystal panel, a sensor such as a CCD array, a thin-film magnetic head, or a micro-machine). In a first step 1001 (design step), the device functions and performance are specified and designed (e.g., the circuit design of an integrated circuit), and a pattern is designed to achieve the design specifications. Next, at step 1002 (reticle-production step), a reticle (or mask) is produced on which is formed the desired circuit pattern. Meanwhile, during step 1003 (substrate-manufacturing step), a substrate (e.g., semiconductor wafer) is produced using a material such as silicon.

Next, at step 1004 (substrate-processing step), the reticle and substrate prepared in steps 1001-1003 are used to transfer the pattern on the reticle to the substrate. This transfer is performed by microlithography, as discussed above. Thus, a layer for an actual circuit or the like is formed on the substrate using a microlithography apparatus as described above. This step is repeated as required to form the desired number of “chips” on the substrate (for a display, a single device can cover the entire substrate) and the desired number of layers in each chip. Next, at step 1005 (device-assembly step), a device is assembled from the “chip” formed in step 1004. During the device-assembly step 1005, processes such as dicing, bonding, and packaging (chip sealing) are performed as required to complete assembly of the device.

Finally, at step 1006 (device testing), qualification and durability tests are performed on the devices, such as operation-confirmation tests. Devices that “pass” step 1006 are ready for shipment.

FIG. 29 provides a flowchart of details of step 1004 as performed during the fabrication of a semiconductor device. In FIG. 29, during step 1011 (oxidation step), a surface of a substrate (semiconductor wafer) is oxidized. An oxide layer (insulation layer) is formed on the wafer surface during step 1012. Formation of the oxide layer typically is performed by chemical vapor deposition, hence the name of this step (CVD step). During step 1013 (electrode-formation step), electrodes are formed on the wafer by metal deposition. During step 1014 (ion-implantation step), ions or other impurities are implanted into the wafer in a controlled manner.

Steps 1011 through 1014 as summarized above comprise “pre-process” or “front-end” steps of wafer fabrication. These steps are selected and executed according to specific respective requirements, depending upon the device to be formed.

When the pre-process steps are completed, “post-process” or “back-end” steps are executed as noted below. Step 1015 (resist-application step) is a first “post-process” step, during which a photosensitive agent (“resist”) is applied to the surface of the wafer. Next, during step 1016 (exposure step), a pattern as defined by a reticle or mask is transferred lithographically to the wafer using the microlithography apparatus described above, resulting in imprinting of the pattern in the layer of resist. Next, during step 1017 (development step), the exposed resist on the wafer is developed so as to make the imprinted image durable. During step 1018 (etching step), the pattern as defined by the developed resist (after unexposed resist has been removed) is used to perform selective etching of the wafer. Then, during step 1019 (resist-removal step) performed after completing the etching step, remaining resist is removed (“stripped”).

By repeatedly executing the pre-process and post-process steps as required, a multi-layer circuit pattern is formed on each chip on the wafer.

The linear motor 100 of the present invention can be used as a drive means in an exposure device other than that described above. For example, the linear motor can be used in a scan-type exposure device as disclosed in U.S. Pat. No. 5,473,410, incorporated herein by reference, in which a reticle and substrate are moved synchronously while the reticle pattern is being exposed.

The stage unit in which the linear motor 100 of the present invention is incorporated also can be used for any of various purposes. For example, the stage unit can be used in a step-and-repeat microlithography apparatus in which the reticle and substrate are stationary during an actual exposure, but the substrate is “stepped” to the next die for exposure of the next chip on the substrate.

The linear motor 100 of the present invention also can be used as a drive means of a proximity-exposure device, in which a mask and substrate are placed in close proximity during exposure of the mask pattern onto the substrate surface.

An exposure apparatus including a linear motor 100 according to the invention is not limited to being used for semiconductor manufacturing. The linear motor 100 also can be used, for example, in an exposure device for exposing an element pattern for a liquid-crystal display on a rectangular glass plate or for exposing patterns for making thin-film magnetic heads.

In the seventh representative embodiment, the source of exposure light can be, for example, a source of g-line light (436 nm), a source of i-line light (365 nm), a KrF excimer laser (248 nm), an ArF excimer laser (193 nm), or an F₂ excimer laser (157 nm). Further alternatively, the exposure beam can be an X-ray beam or a charged particle beam such as an electron beam. For example, an electron beam can be produced as thermoelectric radiation, such as from a lanthanum hexaboride (LaB₆) or tantalum (Ta) gun. When using an electron beam as an exposure-energy beam, the pattern can be defined using a reticle or mask, or can be transferred by “direct-writing” onto the substrate without using a reticle or mask.

If the exposure-energy beam is in the far-ultraviolet portion of the electromagnetic spectrum (e.g., produced by an excimer laser), the illumination-optical system and projection-optical system typically include lens elements that are transmissive to the far-ultraviolet radiation (e.g., quartz or fluorite). If the energy beam is produced by an F₂ excimer laser or is comprised of X-rays, then a catadioptric or reflective optical system is used (along with a reflective-type reticle). If the energy beam is an electron beam, then the illumination-optical system and projection-optical system include electron lenses and deflectors. The electron beam must propagate in a vacuum environment.

The projection-optical system need not be a “reduction” or “demagnifying” system. Alternatively, the projection-optical system can have a magnification of unity or be of a “magnifying” configuration.

When using the linear motor 100 of the present invention in a substrate stage or a reticle stage, either a pneumatic bearing or a magnetic-levitation bearing can be used. The latter generally employs the Lorentz force F or a reactance force.

The stage with which the linear motor of the present invention can be used is not limited to a type that moves along a guide. Alternatively, the stage can be “guideless.”

The reaction force generated by movements of a substrate stage, incorporating a linear motor according to the invention, can be shunted mechanically to a floor or other earth support through a frame, as disclosed in Japan Patent Application No. 8-166475. The reaction force generated by movements of a reticle stage, incorporating a linear motor according to the invention, can be shunted mechanically to a floor or other earth support through a frame, as disclosed in Japan Patent Application No. 8-330224.

An exposure apparatus including a linear motor according to the invention can be manufactured by assembling various subsystems that include respective structural elements so as to maintain a designated accuracy and precision of mechanical characteristics, electrical characteristics, and optical characteristics. To obtain these various levels of accuracy and precision, adjustments can be performed before and/or after specific assembly steps. The process of assembling an exposure apparatus from various subsystems includes mechanical connections, electrical connections, and pneumatic connections, etc., between the various subsystems. Also, there are individual assembly processes for each subsystem.

After assembly of an exposure apparatus from the subsystems is complete, overall system adjustments are made, and various levels of accuracy and precision are secured for the overall apparatus. It is desirable that fabrication of the exposure apparatus be conducted in a clean room in which temperature, degree of cleanliness, etc., are controlled.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A sheet coil, comprising:
an electrically insulative sheet substrate; and
at least one coil formed as a wiring trace of an electrically conductive material in a winding direction on the sheet substrate, the coil being divided by at least one slit extending in the winding direction to form multiple partial coils of the coil.

2. The sheet coil of claim 1, wherein the slit divides the coil into multiple separate partial coils arranged parallel to each other on the sheet substrate, the partial coils of the coil being configured to be energized with AC current having the same phase.

3. The sheet coil of claim 2, wherein:
the said wiring trace is formed in a fixed-cycle waveform; and
the sheet substrate with wiring trace is pleat-folded to form the sheet coil, the pleat-folds being regularly spaced from one another relative to the fixed-cycle waveform.

4. The sheet coil of claim 2, further comprising;
a plurality of individual coils formed on the sheet substrate, the coils forming at least one group; and
a connector unit formed on the sheet substrate for serially connecting together the coils of the group and for serially connecting selected partial coils in the group together.

5. The sheet coil of claim 4, wherein:
a count N_{b} of the partial coils is equal to a divisor of a number of coils N_{c} facing a stator; and
the connector unit serially connects the selected partial coils together at sites that are shifted by one from one partial coil to the next.

6. The sheet coil of claim 4, wherein the connector unit is made of an electrically insulative sheet substrate with connective wiring traces formed thereon of an electrically conductive material, the connector unit being contiguous with the sheet coil.

7. The sheet coil of claim 2, further comprising:
a plurality of individual coils formed on the sheet substrate, the coils forming at least one group; and
a connector unit formed on the sheet substrate for serially connecting together the coils of the group and for serially connecting selected partial coils in the group, the partial coils being selected individually from each of the coils of the group.

8. The sheet coil of claim 7, wherein the connector unit serially connects the partial coils together using at least two partial coils located in symmetrical positions within each coil.

9. A sheet coil, comprising:
an electrically insulative substrate configured as a sheet extending in an longitudinal winding direction;
multiple coils each formed as a respective wiring trace on the insulative substrate and extending in the winding direction;
each coil comprising at least one slit extending in the winding direction so as to form multiple respective partial coils of the coil; and
in each coil, the respective partial coils being situated parallel to each other and identically energized.

10. The sheet coil of claim 9, wherein, in each coil, the respective partial coils are electrically separated from each other on the insulative substrate.

11. The sheet coil of claim 9, wherein, in each coil, the respective partial coils are electrically connected to each other on the insulative substrate by one or more linking units.

12. The sheet coil of claim 9, wherein:
each coil is defined by a respective wiring-trace pattern separated on the insulative substrate from adjacent wiring-trace patterns by a width (w₁); and
with respect to each coil, each partial coil being separated from adjacent partial coils of the coil by a width (w₂), wherein w₂<w₁.

13. The sheet coil of claim 9, wherein:
each coil has a cyclic profile in the winding direction; and
the substrate is pleat-folded along periodic fold lines extending perpendicular to the winding direction.

14. The sheet coil of claim 13, wherein:
the cyclic profile has a period (λ); and
the fold lines are spaced from each other, in the winding direction, by λ/2.

15. The sheet coil of claim 14, wherein:
the cyclic profile is trapezoidal, with mountains and valleys extending in opposite directions perpendicular to the winding direction; and
respective fold lines are situated in each mountain and in each valley.

16. The sheet coil of claim 9, wherein the sheet coil comprises a number of coils that is an integer multiple of 3, so as to form at least one set of three coils.

17. The sheet coil of claim 16, wherein each coil in a set is energized by AC current having a different respective phase.

18. The sheet coil of claim 16, further comprising at least two sets of coils, each set including three respective coils, the coils of the sheet coil being divided into three groups of respective coils, each group including a coil from each set that is energized with a respective phase of 3-phase AC current for the respective group.

19. The sheet coil of claim 18, wherein, in each group, the partial coils of each constituent coil are connected in parallel with each other and the constituent coils are connected in series with each other.

20. The sheet coil of claim 18, wherein:
in each group, the constituent coils are connected in series with each other; and
in each group, the partial coils are connected to each other such that a first partial coil of a first coil is connected in series to a second partial coil of a second coil, a second partial coil of the first coil is connected in series to a third partial coil of the second coil, and a third partial coil of the first coil is connected in series to a first partial coil of the second coil.

21. The sheet coil of claim 20, further comprising an integral connector unit formed on the insulative substrate, the connector unit comprising wiring traces for connecting respective pairs of partial coils together.

22. The sheet coil of claim 18, wherein:
in each group, the constituent coils are connected in series with each other; and
in each group, the partial coils are connected to each other such that a first partial coil of a first coil is connected in series to a third partial coil of a second coil, a second partial coil of the first coil is connected in series to a second partial coil of the second coil, and a third partial coil of the first coil is connected in series to a first partial coil of the second coil.

23. The sheet coil of claim 22, further comprising an integral connector unit formed on the insulative substrate, the connector unit comprising wiring traces for connecting respective pairs of partial coils together.

24. The sheet coil of claim 9, comprising multiple sets of coils, wherein each set includes (m) coils (m≧2), and each coil has (m−1) slits that form (n) partial coils of the coil (n=m).

25. The sheet coil of claim 9, comprising multiple sets of coils, wherein each set includes (m) coils (m≧2), and each coil has (k−1) slits that form a number of partial coils equal to a divisor (k), including m, of the number (m) of coils.

26. The sheet coil of claim 9, further comprising an integral connector unit formed on the insulative substrate, the connector unit being configured to connect selected partial coils together.

27. A linear motor, comprising an armature including the sheet coil of claim 1.

28. A stage unit, comprising the linear motor of claim 27.

29. A lithographic exposure apparatus, comprising the stage unit of claim 28.

30. A linear motor, comprising an armature including the sheet coil of claim 9.

31. A stage unit, comprising the linear motor of claim 29.

32. A lithographic exposure apparatus, comprising the stage unit of claim 31.

33. A method for manufacturing a microelectronic device, comprising the steps:
(a) preparing a substrate;
(b) processing the substrate; and
(c) assembling devices formed on the substrate during steps (a) and (b),
wherein step (b) comprises the steps of (i) applying a resist to the substrate; (ii) exposing the resist; and (iii) developing the resist; and step (ii) comprises providing a lithographic exposure apparatus as recited in claim 29; and using the lithographic exposure apparatus to expose the resist with the pattern defined on the reticle.

34. A method for manufacturing a microelectronic device, comprising the steps:
(a) preparing a substrate;
(b) processing the substrate; and
(c) assembling devices formed on the substrate during steps (a) and (b),
wherein step (b) comprises the steps of (i) applying a resist to the substrate; (ii) exposing the resist; and (iii) developing the resist; and step (ii) comprises providing a lithographic exposure apparatus as recited in claim 32; and using the lithographic exposure apparatus to expose the resist with the pattern defined on the reticle.
